(19) United States
(12) Patent Application Publication
(10) Pub. No.: US 2026/0029589 A1
(43) Pub. Date: Jan. 29, 2026

(54) PHOTONIC CHIP STRUCTURE AND SEMICONDUCTOR PACKAGE INCLUDING THE SAME

(71) Applicant: SAMSUNG ELECTRONICS CO., LTD., Suwon-si (KR)

(72) Inventors: Jung Hua CHANG, Suwon-si (KR); Jing Cheng LIN, Suwon-si (KR)

(73) Assignee: SAMSUNG ELECTRONICS CO., LTD., Suwon-si (KR)

(21) Appl. No.: 19/098,469

(22) Filed: Apr. 2, 2025

(30) Foreign Application Priority Data
Jul. 25, 2024 (KR) 10-2024-0098919

(51) Int. Cl. G02B 6/42

(52) U.S. Cl. CPC G02B 6/4214

(57) ABSTRACT

A photonic chip structure includes: an optical integrated circuit chip including a photonic integrated circuit (PIC) connection pad on a first surface of the optical integrated circuit chip; an electronic integrated circuit chip below the first surface of the optical integrated circuit chip and including a through-electrode; a connection layer between the electronic integrated circuit chip and the optical integrated circuit chip and including a conductive pad bonded to the PIC connection pad; and a lens on a second surface of the optical integrated circuit chip opposite to the first surface of the optical integrated circuit chip, the lens configured to receive an optical signal, wherein the optical integrated circuit chip includes a grating coupler configured to couple the optical signal received via the lens.

### CROSS-REFERENCE TO RELATED APPLICATION

This application is based on and claims priority under 35 U.S.C. § 119 to Korean Patent Application No. 10-2024-0098919, filed on Jul. 25, 2024, in the Korean Intellectual Property Office, the disclosure of which is incorporated by reference herein in its entirety.

### BACKGROUND

The embodiments of the present disclosure relate to a photonic chip structure and a semiconductor package including the photonic chip structure, and more particularly, to a photonic chip structure having an optical integrated circuit chip and a semiconductor package including the photonic chip structure.

In order to improve the functionality of electronic equipment and integrate components thereof, the advantages of semiconductor packages are increasingly being utilized. In the semiconductor packages, various integrated circuits, such as memory chips and logic chips, may be mounted on package substrates. Recently, in an environment in which data traffic is increasing in data centers and communication infrastructure, research is being conducted on semiconductor packages including optical integrated circuits. However, the temperature stability of components of the optical integrated circuits is not easy to be controlled due a location far away from a cooling system. Furthermore, a light wavelength is impacted by temperature, where larger temperatures result in large light wavelength variation, and thus, poor stability of the optical integrated circuits. Furthermore, the thickness of components of the optical integrated circuits needs to be reduced due to signal bandwidth limits, thereby leading to robustness problems.

### SUMMARY

The embodiments of the present disclosure provide a more compact and thermally stable photonic chip structure and a semiconductor package including the photonic chip structure.

The objects of the present disclosure are not limited to the object mentioned above, but other objects not described herein will be clearly understood by those skilled in the art from the following description.

According to an aspect of the disclosure, a photonic chip structure includes: an optical integrated circuit chip comprising a photonic integrated circuit (PIC) connection pad on a first surface of the optical integrated circuit chip; an electronic integrated circuit chip below the first surface of the optical integrated circuit chip and comprising a through-electrode; a connection layer between the electronic integrated circuit chip and the optical integrated circuit chip and comprising a conductive pad bonded to the PIC connection pad; and a lens on a second surface of the optical integrated circuit chip opposite to the first surface of the optical integrated circuit chip, the lens configured to receive an optical signal, wherein the optical integrated circuit chip comprises a grating coupler configured to couple the optical signal received via the lens.

According to an aspect of the disclosure, a semiconductor package including: a package substrate; an interposer mounted on the package substrate; a first chip structure mounted on the interposer and a second chip structure mounted on the interposer, the first chip structure and the second chip structure spaced apart from each other in a first direction; and a photonic chip structure spaced apart from the first chip structure in the first direction, wherein the photonic chip structure includes: an optical integrated circuit chip comprising a photonic integrated circuit (PIC) connection pad disposed on a first surface of the optical integrated circuit chip; an electronic integrated circuit chip below the first surface of the optical integrated circuit chip and comprising a through-electrode; a connection layer between the electronic integrated circuit chip and the optical integrated circuit chip and comprising a conductive pad aligned with the PIC connection pad; and a lens disposed above a second surface of the optical integrated circuit chip opposite to the first surface of the optical integrated circuit chip, the lens configured to receive an optical signal, wherein the optical integrated circuit chip comprises a grating coupler configured to couple the optical signal received via the lens.

According to an aspect of the disclosure, a semiconductor package including: a package substrate; an interposer mounted on the package substrate; a memory chip structure mounted on the interposer; a non-memory chip structure mounted on the interposer and spaced apart from the memory chip structure in a first direction; and a photonic chip structure spaced apart from the memory chip structure in the first direction with the non-memory chip structure between the photonic chip structure and the memory chip structure, wherein the photonic chip structure includes: an optical integrated circuit chip comprising a photonic integrated circuit (PIC) connection pad on a first surface of the optical integrated circuit chip; an electronic integrated circuit chip below the first surface of the optical integrated circuit chip and comprising a through-electrode; a connection layer between the electronic integrated circuit chip and the optical integrated circuit chip, the connection layer comprising a conductive pad bonded to the PIC connection pad; and a lens above a second surface of the optical integrated circuit chip opposite to the first surface thereof and configured to receive an optical signal, wherein the optical integrated circuit chip further comprises a grating coupler configured to couple the optical signal received via the lens, a reflective pad below the grating coupler and overlapping the grating coupler in a second direction perpendicular to the first direction, and a dielectric layer surrounding the reflective pad.

### BRIEF DESCRIPTION OF DRAWINGS

Embodiments will be more clearly understood from the following detailed description taken in conjunction with the accompanying drawings in which:

FIG. 1 is a cross-sectional view of a semiconductor package according to one or more embodiments;

FIG. 2 is a cross-sectional view of a photonic chip structure illustrated in FIG. 1;

FIG. 3 is a cross-sectional view of a photonic chip structure according to another embodiment;

FIG. 4 is an enlarged view of region “CX” of FIG. 3;

FIGS. 5 to 13 are cross-sectional views illustrating a manufacturing process of a photonic chip structure, according to one or more embodiments; and

FIGS. 14 to 27 are cross-sectional views illustrating a manufacturing process of an optical integrated circuit chip, according to one or more embodiments.

### DETAILED DESCRIPTION

Hereinafter, embodiments are described in detail with reference to the accompanying drawings. The same reference numerals are given to the same elements in the drawings, and repeated descriptions thereof are omitted.

It will be understood that, although the terms first, second, third, fourth, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

A layer may be described as having an upper surface and a lower surface. As understood by one of ordinary skill in the art, the surfaces of a layer may also be described as first and second surfaces, where a first surface may be one of the upper surface and the lower surface of the layer, and the second surface may be the other of the upper surface and the lower surface of the layer.

The specification uses the terms of degree including “substantially” or “about.” In one or more examples, when specifying that a parameter X may be substantially the same as parameter Y, the term “substantially” may be understood as X being within 10% of Y. In one or more examples, when specifying that a parameter is about X, the term “about” may be understood as being within 10% of X.

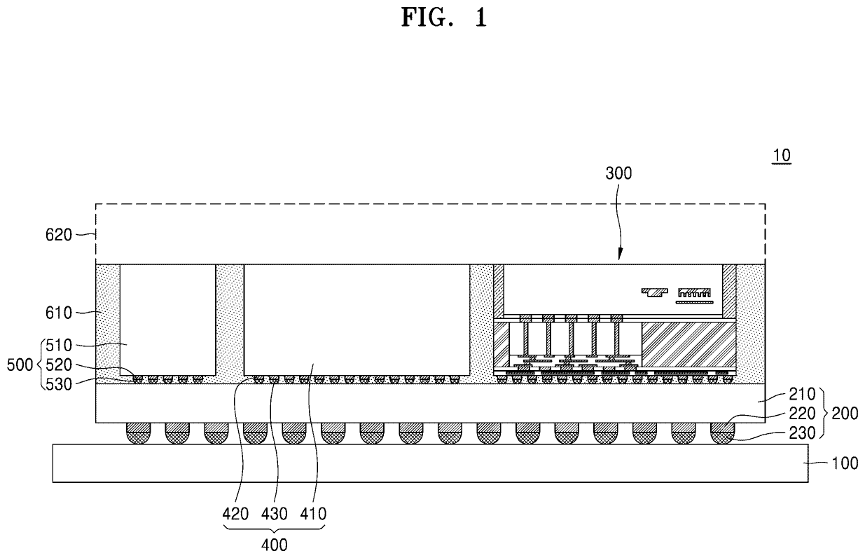

FIG. 1 is a cross-sectional view of a semiconductor package 10 according to one or more embodiments.

In FIG. 1, the semiconductor package 10 according to one or more embodiments may include a package substrate 100, an interposer 200, a photonic chip structure 300, a first chip structure 400, a second chip structure 500, a package molding layer 610, and a cooling system 620.

A detailed description of the photonic chip structure 300a is given below, and other components are described first. Hereinafter, unless otherwise specifically defined, in one or more examples, a direction parallel to the upper surface of the package substrate 100 is defined as a first horizontal direction (an X direction), a direction perpendicular to the upper surface of the package substrate 100 is defined as a vertical direction (a Z direction), and a direction perpendicular to both the first horizontal direction (the X direction) and the vertical direction (the Z direction) is defined as a second horizontal direction (a Y direction). A direction obtained by synthesizing the first horizontal direction (the X direction) and the second horizontal direction (the Y direction) is defined as a horizontal direction.

The package substrate 100 may include, for example, a printed circuit board (PCB). The package substrate 100 may have an upper surface sufficiently wide to accommodate the interposer 200. The package substrate 100 may include a core insulating layer containing at least one material selected from a group consisting of phenolic resin, epoxy resin, and polyimide. For example, the core insulating layer may include, for example, at least one material selected from a group consisting of polyimide, flame retardant 4 (FR-4), tetrafunctional epoxy, polyphenylene ether, epoxy/polyphenylene oxide, bismaleimide triazine (BT), Thermount, cyanate ester, and liquid crystal polymer.

According to one or more embodiments, the interposer 200 may include an interposer substrate 210, an interposer pad 220, and an interposer bump 230. In one or more examples, as understood by one of ordinary skill in the art, an interposer may be an electrical interface routing between one socket or connection to another. The purpose of an interposer is to spread a connection to a wider pitch or to reroute a connection to a different connection.

In one or more embodiments, the interposer 200 may be located between the package substrate 100 and a plurality of chip structures (e.g., the photonic chip structure 300a, the first chip structure 400, and the second chip structure 500) and may be configured to electrically connect the plurality of chip structures to each other. For example, the photonic chip structure 300a, the first chip structure 400, and the second chip structure 500 may transmit an electrical signal to or receive an electrical signal from each other via the interposer 200.

For example, the material of the interposer substrate 210 may include silicon (Si). However, the embodiment is not limited thereto, and the interposer substrate 210 may include semiconductor elements, such as germanium, and may also include semiconductor compounds, such as silicon carbide (SiC), gallium arsenide (GaAs), indium arsenide (InAs), and indium phosphide (InP), or any other suitable material known to one of ordinary skill in the art.

The interposer pad 220 may be located on the lower surface of the interposer substrate 210 and may provide a terminal on which the interposer bump 230 is disposed. In one or more examples, a plurality of through-electrodes or a plurality of wiring patterns may be formed in the interposer substrate 210. The plurality of through-electrodes and the plurality of wiring patterns may be connected to the interposer pad 220.

In one or more embodiments, the material of the interposer pad 220 may include aluminum (Al). However, the embodiment is not limited thereto, and the material of the interposer pad 220 may include metals, such as nickel (Ni), copper (Cu), gold (Au), silver (Ag), tungsten (W), titanium (Ti), tantalum (Ta), indium (In), molybdenum (Mo), manganese (Mn), cobalt (Co), tin (Sn), magnesium (Mg), rhenium (Re), beryllium (Be), gallium (Ga), and ruthenium (Ru), alloys thereof, or any other suitable material known to one of ordinary skill in the art.

The interposer bump 230 may include a terminal for electrically connecting the interposer 200 to the package substrate 100 disposed below the interposer 200. In one or more embodiments, the interposer bump 230 may include a solder of a metal material including at least one of tin (Sn), silver (Ag), copper (Cu), and aluminum (Al).

The photonic chip structure 300a, the first chip structure 400, and the second chip structure 500 may be mounted on the upper surface of the interposer 200. According to one or more embodiments, the photonic chip structure 300a may be located on an outer region of the upper surface of the interposer 200. The photonic chip structure 300a, the second chip structure 500, and the first chip structure 400 may be arranged at a same vertical level on the interposer 200. For example, an uppermost surface of the photonic chip structure 300a, an uppermost surface of the second chip structure 500, and an uppermost surface of the first chip structure 400 may all be located on the same plane.

According to one or more embodiments, the first chip structure 400 may be located adjacent to the central region of the upper surface of the interposer substrate 210, and the second chip structure 500 may be spaced apart from the photonic chip structure 300a in the first horizontal direction (the X direction) with the first chip structure 400 therebetween. In one or more examples, the distance between the first chip structure 400 and the second chip structure 500 in the first horizontal direction (the X direction) may be substantially the same as the distance between the first chip structure 400 and the photonic chip structure 300a in the first horizontal direction (the X direction).

The first chip structure 400 may include a first chip body 410, a first chip pad 420, and a first chip bump 430. In one or more examples, the first chip structure 400 may include a non-memory chip structure including a non-memory device. The first chip body 410 may include, for example, silicon. In one or more examples, the first chip body 410 may include semiconductor elements, such as germanium, or compound semiconductors, such as silicon carbide (SiC), gallium arsenide (GaAs), indium arsenide (InAs), and indium phosphide (InP). In one or more examples, the first chip body 410 may have a silicon on insulator (SOI) structure. For example, the first chip body 410 may have a buried oxide (BOX) layer. The first chip body 410 may include a conductive region, for example, a well doped with impurities or a structure doped with impurities. In one or more examples, the first chip body 410 may have various device isolation structures, such as a shallow trench isolation (STI) structure.

The first chip structure 400 may include, for example, a system on chip (SoC), a central processing unit (CPU) chip, a graphics processing unit (GPU) chip, or an application processor (AP) chip. The first chip structure 400 may execute applications, provided by the semiconductor package 10, using a memory device of the second chip structure 500. For example, the first chip structure 400 may include at least one processor among a CPU, an AP, a GPU, a neural processing unit (NPU), a tensor processing unit (TPU), a vision processing unit (VPU), an image signal processor (ISP), and a digital signal processor (DSP) to execute specialized operations.

According to one or more embodiments, a plurality of first chip pads 420 may be arranged, in lateral directions (the X direction and/or the Y direction), on the lower surface of the first chip body 410. According to one or more embodiments, the upper surface of the first chip pad 420 may be coplanar with the lower surface of the first chip body 410, and the first chip pad 420 may be in contact with the first chip bump 430. The first chip pad 420 may receive an electrical signal from the second chip structure 500 or the photonic chip structure 300a via the interposer 200 or transmit an electrical signal to the second chip structure 500 or the photonic chip structure 300a.

The first chip pad 420 may include a conductive material that includes, for example, copper (Cu), gold (Au), silver (Ag), nickel (Ni), tungsten (W), aluminum (Al), or a combination thereof. In some embodiments, the first chip pad 420 may further include a barrier material to prevent the conductive material from diffusing out of the first chip pad 420. The barrier materials may include, for example, titanium (Ti), tantalum (Ta), titanium nitride (TiN), tantalum nitride (TaN), a combination thereof, or any other suitable material known to one of ordinary skill in the art.

According to one or more embodiments, a plurality of first chip bumps 430 may be respectively attached to the plurality of first chip pads 420 of the first chip body 410. The first chip bump 430 may include a conductive material that includes, for example, tin (Sn), lead (Pb), silver (Ag), copper (Cu), or a combination thereof. The first chip bump 430 may be formed using, for example, a solder ball. The first chip bump 430 may connect the first chip structure 400 to the interposer 200. In one or more examples, a semiconductor chip bump may be a raised area of metal that connects two components in a semiconductor package. Bumps may be created using a manufacturing process called wafer bumping, which is a key part of semiconductor packaging. Bumps may be used in place of wire bonding to improve the electrical, mechanical, and thermal performance of a semiconductor device.

The second chip structure 500 may include a second chip body 510, a second chip pad 520, and a second chip bump 530. As used herein, the second chip structure 500 may include a memory chip structure including a memory device. The second chip body 510 may include, for example, silicon. In one or more examples, the second chip body 510 may include semiconductor elements, such as germanium, or compound semiconductors, such as silicon carbide (SiC), gallium arsenide (GaAs), indium arsenide (InAs), and indium phosphide (InP). In one or more examples, the second chip body 510 may have an SOI structure. For example, the second chip body 510 may have a BOX layer. The second chip body 510 may include a conductive region, for example, a well doped with impurities or a structure doped with impurities. In one or more examples, the second chip body 510 may have various device isolation structures, such as an STI structure.

The second chip structure 500 may include, for example, dynamic random-access memory (DRAM), static random-access memory (SRAM), flash memory, electrically erasable and programmable read-only memory (EPROM), phase-change random-access memory (PRAM), magnetic random-access memory (MRAM), resistive random-access memory (RRAM), or any other memory structure known to one of ordinary skill in the art. According to one or more embodiments, the second chip structure 500 may include a memory cell chip having cells of high bandwidth memory (HBM) DRAM.

According to one or more embodiments, a plurality of second chip pads 520 may be arranged, in the lateral directions (the X direction and/or the Y direction), on the lower surface of the second chip body 510. According to one or more embodiments, the upper surface of the second chip pad 520 may be coplanar with the lower surface of the second chip body 510, and the second chip pad 520 may be in contact with the second chip bump 530. The structure of the second chip bump 530 may be similar to the structure of the plurality of first chip bumps 430. The second chip pad 520 may receive an electrical signal from the first chip structure 400 or the photonic chip structure 300a via the interposer 200 or transmit an electrical signal to the first chip structure 400 or the photonic chip structure 300a.

The second chip pad 520 may include a conductive material that includes, for example, copper (Cu), gold (Au), silver (Ag), nickel (Ni), tungsten (W), aluminum (Al), or a combination thereof. In some embodiments, the second chip pad 520 may further include a barrier material to prevent the conductive material from diffusing out of the second chip pad 520. The barrier materials may include, for example, titanium (Ti), tantalum (Ta), titanium nitride (TiN), tantalum nitride (TaN), or a combination thereof.

According to one or more embodiments, a plurality of second chip bump 530 may be respectively attached to the plurality of second chip pads 520 of the second chip body 510. The second chip bump 530 may include a conductive material that includes, for example, tin (Sn), lead (Pb), silver (Ag), copper (Cu), or a combination thereof. The second chip bump 530 may be formed using, for example, a solder ball. The second chip bump 530 may connect the second chip structure 500 to the interposer 200.

According to one or more embodiments, the package molding layer 610 may seal the first chip structure 400, the second chip structure 500, and the photonic chip structure 300a on the upper surface of the interposer 200. In one or more examples, the package molding layer 610 may cover side surfaces of the first chip structure 400, the second chip structure 500, and the photonic chip structure 300a. A single package molding layer 610 seals devices arranged in the semiconductor package 10, and thus, warpage of the semiconductor package 10 may be alleviated.

The package molding layer 610 may include, for example, thermosetting resin, such as epoxy resin, thermoplastic resin, such as polyimide, or resin formed by adding inorganic fillers to the thermosetting resin or the thermoplastic resin, specifically such as ABF, FR-4, and BT. In one or more examples, the package molding layer 610 may include a molding material, such as an epoxy molding compound (EMC), or a photosensitive material, such as a photo imageable encapsulant (PIE).

According to one or more embodiments, the cooling system 620 may be disposed on the upper surface of the package molding layer 610. The cooling system 620 may be disposed on the upper surfaces of the photonic chip structure 300a, the first chip structure 400, and the second chip structure 500. As is described in detail below, the cooling system 620 is disposed on the upper surface of the photonic chip structure 300a. In one or more examples, an optical integrated circuit chip 350 generating high-temperature heat is exposed to the cooling system 620, and thus, thermal stability may be improved.

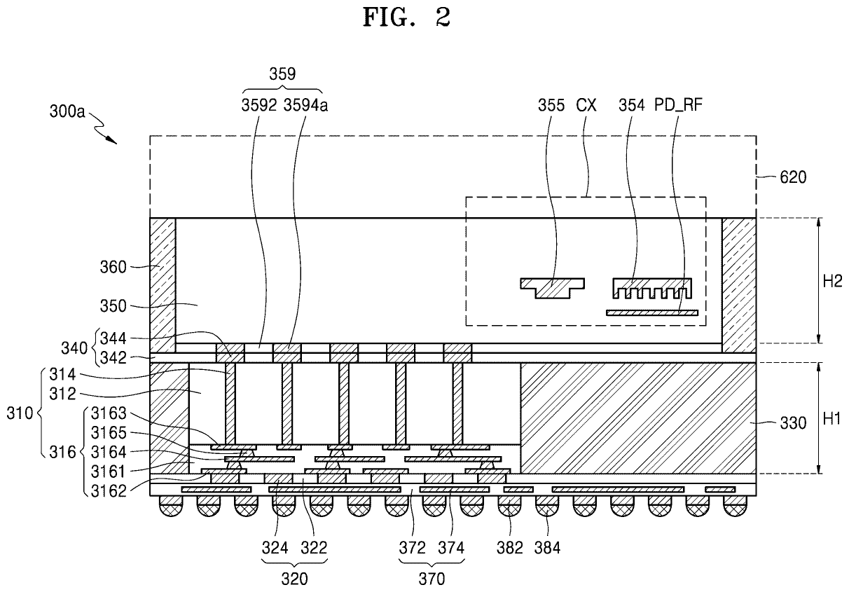

FIG. 2 is a cross-sectional view of the photonic chip structure 300a illustrated in FIG. 1.

Referring to FIG. 2, the photonic chip structure 300a may include an electronic integrated circuit chip 310, a lower connection layer 320, an outer insulating layer 330, an upper connection layer 340, an optical integrated circuit chip 350, a molding layer 360, a redistribution structure 370, a photonic chip pad 382, and a photonic chip bump 384.

The electronic integrated circuit chip 310 may include a first substrate 312, an electric integrated circuit (EIC) through-electrode 314, and an EIC wiring portion 316.

The electronic integrated circuit chip 310 may be stacked on the lower connection layer 320. The first substrate 312 may include, for example, a semiconductor material, such as silicon (Si). In one or more examples, the first substrate 312 may include a semiconductor material, such as germanium (Ge).

The first substrate 312 may have an active surface, on which a plurality of individual devices are formed, and an inactive surface opposite to the active surface. In one or more examples, the active surface of the first substrate 312 may correspond to the lower surface of the first substrate 312, and the inactive surface of the first substrate 312 may correspond to the upper surface of the first substrate 312. The lower surface of the first substrate 312 may face the EIC wiring portion 316. The EIC through-electrode 314 may pass through the first substrate 312 from the active surface of the first substrate 312 to the inactive surface of the first substrate 312. In one or more examples, the lower end of the EIC through-electrode 314 may be physically and electrically connected to an EIC upper pad 3163, and the upper end of the EIC through-electrode 314 may be physically and electrically connected to an upper pad 344.

According to one or more embodiments, the EIC wiring portion 316 may be disposed on the active surface of the first substrate 312. The EIC wiring portion 316 may include an EIC insulating layer 3161, an EIC lower pad 3162, the EIC upper pad 3163, an EIC conductive pattern 3164, and an EIC conductive via 3165.

The EIC insulating layer 3161 may be formed, at a constant thickness, along the active surface (e.g., the lower surface) of the first substrate 312. In one or more examples, the EIC insulating layer 3161 may include an inorganic insulating layer, such as silicon oxide (SiO) and silicon nitride (SiN). In one or more examples, the EIC insulating layer 3161 may include a polymer material. In one or more examples, the EIC insulating layer 3161 may include an insulating polymer or a photosensitive polymer (e.g., a photo imageable dielectric (PID)). For example, the photosensitive polymer may include at least one of a photosensitive polyimide, a polybenzoxazole (PBO), a phenol-based polymer, and a benzocyclobutene-based polymer. The EIC insulating layer 3161 may include two or more insulating materials stacked on each other.

The EIC upper pad 3163 may be disposed on the upper surface of the EIC insulating layer 3161, and the EIC lower pad 3162 may be disposed on the lower surface of the EIC insulating layer 3161. For example, the EIC upper pad 3163 may be exposed from the upper surface of the EIC insulating layer 3161, and a plurality of EIC upper pads 3163 may provide terminals for connection with EIC through-electrodes 314. The EIC lower pad 3162 may be exposed from the lower surface of the EIC insulating layer 3161 and provide a terminal for connection with a lower pad 324 of the lower connection layer 320. The EIC upper pad 3163 and the EIC lower pad 3162 may each include a metal material, for example, at least one metal or an alloy including two or more metals, among copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), carbon (C), or any other suitable material known to one of ordinary skill in the art.

The EIC conductive pattern 3164 may be provided in plurality, and the plurality of EIC conductive patterns 3164 may be at different vertical levels in the EIC insulating layer 3161. The EIC conductive patterns 3164 may redistribute the EIC upper pads 3163 and the EIC lower pads 3162. The EIC conductive patterns 3164 may perform various functions depending on the design of patterns. For example, the EIC conductive patterns 3164 may include ground patterns, power patterns, signal patterns, etc. The signal patterns may include various signals other than the ground patterns, power patterns, etc., for example, may include data signals, etc. In one or more examples, the patterns may include the wires and pads.

The EIC conductive pattern 3164 may include a conductive material that includes, for example, copper (Cu), gold (Au), silver (Ag), nickel (Ni), tungsten (W), aluminum (Al), or a combination thereof. In some embodiments, the EIC conductive pattern 3164 may further include a barrier material to prevent the conductive material from diffusing out of the EIC conductive pattern 3164. The barrier materials may include, for example, titanium (Ti), tantalum (Ta), titanium nitride (TiN), tantalum nitride (TaN), or a combination thereof.

EIC conductive vias 3165 may electrically connect the plurality of EIC conductive patterns 3164, EIC upper pads 3163, EIC lower pads 3162 at different vertical levels to each other, and thus, an electrical path may be formed in the EIC wiring portion 316. The EIC conductive via 3165 may include metal materials, such as copper (Cu), aluminum (Al), silver (Ag), tin (Sn), gold (Au), nickel (Ni), lead (Pb), titanium (Ti), and an alloy thereof. The EIC conductive via 3165 may be of a field type, which is filled with a metal material, or may be of a conformal type in which a metal material is formed along a wall surface of a via hole. The EIC conductive via 3165 may have a tapered cross-section. For example, the EIC conductive vias 3165 may each have a tapered shape in which the width at the top of the cross-section is less than the width at the bottom of the cross-section. In some embodiments, the EIC conductive via 3165 may further include a barrier material to prevent the conductive material from diffusing out of the EIC conductive via 3165. The barrier materials may include, for example, titanium (Ti), tantalum (Ta), titanium nitride (TiN), tantalum nitride (TaN), or a combination thereof.

According to one or more embodiments, the lower connection layer 320 may be disposed below the electronic integrated circuit chip 310 in the vertical direction (the Z direction). The lower connection layer 320 provides a space in which the electronic integrated circuit chip 310 is mounted, and also provides an electrical connection path between the electronic integrated circuit chip 310 and the redistribution structure 370.

The lower connection layer 320 may include a lower insulating layer 322 and the lower pad 324. The lower insulating layer 322 may be formed, at a constant thickness, along the lower surface of the EIC wiring portion 316 and the lower surface of the outer insulating layer 330. In one or more examples, the lower insulating layer 322 may include an inorganic insulating layer, such as silicon oxide (SiO) and silicon nitride (SiN). In one or more examples, the lower insulating layer 322 may include a polymer material. In one or more examples, the lower insulating layer 322 may include an insulating polymer or a photosensitive polymer (a PID). For example, the photosensitive polymer may include at least one of a photosensitive polyimide, a polybenzoxazole (PBO), a phenol-based polymer, and a benzocyclobutene-based polymer. The lower insulating layer 322 may include two or more insulating materials stacked on each other.

In a plan view, the outer perimeter of the lower insulating layer 322 may correspond to the outer perimeter of the outer insulating layer 330.

The side surfaces of the lower pad 324 may be surrounded by the lower insulating layer 322.

The lower pad 324 may be located inside the lower insulating layer 322. In one or more examples, the lower pad 324 may be exposed through the upper surface of the lower insulating layer 322 and also exposed through the lower surface of the lower insulating layer 322. A plurality of lower pads 324 may serve as connection terminals between the EIC wiring portion 316 and the redistribution structure 370. The lower pad 324 may include a metal material, for example, at least one metal or an alloy including two or more metals, among copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), carbon (C), or any other suitable materials known to one of ordinary skill in the art.

According to one or more embodiments, the redistribution structure 370 may be disposed below the lower connection layer 320 in the vertical direction (the Z direction). The redistribution structure 370 may extend along the lower surface of the lower connection layer 320 and provide an electrical connection path between the photonic chip bump 384 and the lower connection layer 320.

The redistribution structure 370 may include a redistribution insulating layer 372 and a redistribution pattern layer 374. The redistribution insulating layer 372 may be formed, at a constant thickness, along the lower surface of the lower insulating layer 322 of the lower connection layer 320. In one or more examples, the redistribution insulating layer 372 may include an inorganic insulating layer, such as silicon oxide (SiO) and silicon nitride (SiN). In one or more examples, the redistribution insulating layer 372 may include a polymer material. Alternatively, the redistribution insulating layer 372 may include an insulating polymer or a photosensitive polymer (a PID). For example, the photosensitive polymer may include at least one of a photosensitive polyimide, a polybenzoxazole (PBO), a phenol-based polymer, and a benzocyclobutene-based polymer. The redistribution insulating layer 372 may include two or more insulating materials stacked on each other.

The redistribution pattern layer 374 may be located inside the redistribution insulating layer 372. The redistribution pattern layer 374 may be provided in plurality. Although schematically illustrated in the diagram, the plurality of redistribution pattern layers 374 may be at different vertical levels inside the redistribution insulating layer 372. The redistribution pattern layers 374 may redistribute photonic chip pads 382 and the lower pads 324. The redistribution pattern layers 374 may perform various functions depending on the design of patterns. For example, the redistribution pattern layers 374 may include ground patterns, power patterns, signal patterns, etc. The signal patterns may include various signals other than the ground patterns, power patterns, etc., for example, may include data signals, etc. In one or more examples, the patterns may include the wires and pads. In one or more examples, although not illustrated in detail in the drawing, the plurality of redistribution pattern layers 374 may be at different vertical levels. Redistribution vias may be connected between the redistribution pattern layers 374 at different vertical levels.

The redistribution pattern layer 374 may include a conductive material that includes, for example, copper (Cu), gold (Au), silver (Ag), nickel (Ni), tungsten (W), aluminum (Al), or a combination thereof. In some embodiments, the redistribution pattern layer 374 may further include a barrier material to prevent the conductive material from diffusing out of the redistribution pattern layer 374. The barrier materials may include, for example, titanium (Ti), tantalum (Ta), titanium nitride (TiN), tantalum nitride (TaN), or a combination thereof.

According to one or more embodiments, the photonic chip pads 382 may be arranged, in the lateral directions (the X direction and/or the Y direction), on the lower surface of the redistribution structure 370. The photonic chip pad 382 may be located on the lower surface of the redistribution structure 370 and may provide a terminal on which the photonic chip bump 384 is disposed. In one or more examples, a plurality of through-electrodes or a plurality of wiring patterns may be formed in the interposer substrate 210. The plurality of through-electrodes and the plurality of wiring patterns may be connected to the photonic chip pad 382.

In one or more embodiments, the material of the photonic chip pad 382 may include aluminum (Al). However, the embodiment is not limited thereto, and the material of the photonic chip pad 382 may include metals, such as nickel (Ni), copper (Cu), gold (Au), silver (Ag), tungsten (W), titanium (Ti), tantalum (Ta), indium (In), molybdenum (Mo), manganese (Mn), cobalt (Co), tin (Sn), magnesium (Mg), rhenium (Re), beryllium (Be), gallium (Ga), and ruthenium (Ru), or alloys thereof.

The photonic chip bump 384 may include a terminal for electrical connection with the interposer 200. In one or more embodiments, the photonic chip bump 384 may include a solder of a metal material including at least one of tin (Sn), silver (Ag), copper (Cu), and aluminum (Al).

According to one or more embodiments, the outer insulating layer 330 on the upper surface of the lower connection layer 320 may be configured to seal the electronic integrated circuit chip 310. The electronic integrated circuit chip 310 may be located offset, in the lateral directions (the X direction and/or the Y direction) from the central region of the outer insulating layer 330 in a plan view. In this case, the upper surface of the outer insulating layer 330 may be coplanar with the upper surface of the electronic integrated circuit chip 310. Accordingly, the upper surface of the electronic integrated circuit chip 310 may be exposed from the outer insulating layer 330 in a plan view. The outer insulating layer 330 may include, for example, an EMC.

In one or more embodiments, the upper connection layer 340 may be located between the electronic integrated circuit chip 310 and the optical integrated circuit chip 350. The upper connection layer 340 may electrically connect the optical integrated circuit chip 350 to the electronic integrated circuit chip 310. The lower surface of the upper connection layer 340 may be in contact with the upper surface of the electronic integrated circuit chip 310, and the upper surface of the upper connection layer 340 may be in contact with the lower surface of the optical integrated circuit chip 350.

The upper connection layer 340 may include an upper insulating layer 342 and an upper pad 344. The upper insulating layer 342 may extend, at a constant thickness, along the upper surface of the first substrate 312 of the electronic integrated circuit chip 310 and the upper surface of the outer insulating layer 330. In one or more examples, since the material of the upper insulating layer 342 is substantially the same as the material of the lower insulating layer 322, a detailed description thereof is omitted below.

In a plan view, the outer perimeter of the upper insulating layer 342 may correspond to the outer perimeter of the outer insulating layer 330.

The side surfaces of the upper pad 344 may be surrounded by the upper insulating layer 342.

The upper pad 344 may be located inside the upper insulating layer 342. In one or more examples, the upper pad 344 may be exposed through the upper surface of the upper insulating layer 342 and also exposed through the lower surface of the upper insulating layer 342. A plurality of upper pads 344 may serve as connection terminals between the electronic integrated circuit chip 310 and the optical integrated circuit chip 350. Since the material of the upper pad 344 is substantially the same as the material of the lower pad 324, a detailed description thereof is omitted below.

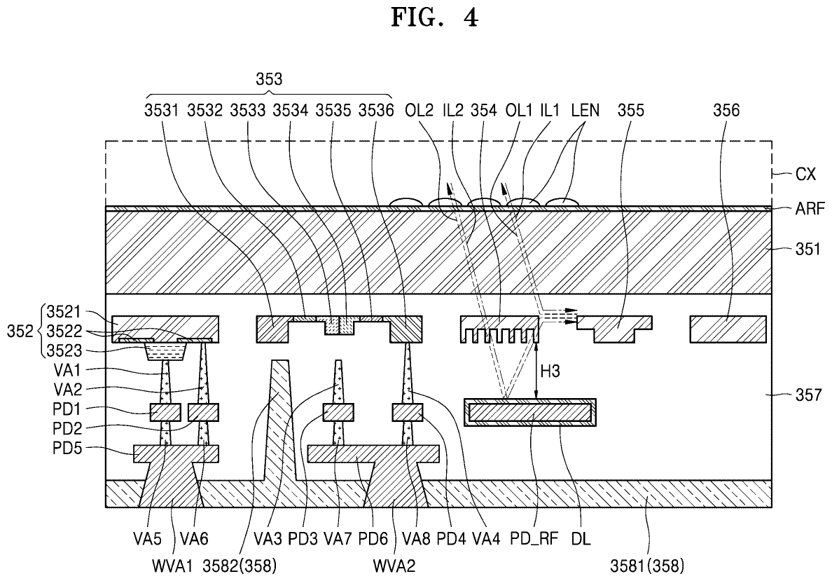

In one or more embodiments, the optical integrated circuit chip 350 may be disposed on the upper connection layer 340. Components in the optical integrated circuit chip 350 are described in detail below with reference to FIG. 4.

The optical integrated circuit chip 350 may be disposed on the upper insulating layer 342 and electrically connected to the electronic integrated circuit chip 310 disposed below the upper insulating layer 342. The upper surface of the optical integrated circuit chip 350 may be exposed to the cooling system 620. The cooling system 620 may be configured to cool the high-temperature optical integrated circuit chip 350. For example, the cooling system 620 may include a thermal electric cooler (TEC). When the cooling system 620 includes a TEC, the cooling system 620 operates as a cooler that generates heat flux between two material junctions by using the Peltier effect. This cooler may cool the optical integrated circuit chip 350 by utilizing a mechanism that transfers heat from one side of a device to the other side while consuming electric energy in the direction of the current. In one or more examples, the cooling system 620 may represent air outside the photonic chip structure 300a. When the cooling system 620 represents the outside air, the upper surface of the optical integrated circuit chip 350 is exposed to the outside air so that high temperature heat may be cooled.

The optical integrated circuit chip 350 may include a grating coupler 354, a rib waveguide 355, and a reflective pad PD_RF. This is described below in detail with reference to FIG. 4.

According to one or more embodiments, the molding layer 360 on the upper surface of the upper connection layer 340 may be configured to seal the optical integrated circuit chip 350. In this case, the upper surface of the molding layer 360 may be coplanar with the upper surface of the optical integrated circuit chip 350. Accordingly, the upper surface of the optical integrated circuit chip 350 may be exposed from the molding layer 360 in a plan view. In a plan view, the perimeter of the molding layer 360 may correspond to the perimeter of the upper connection layer 340. The molding layer 360 on the upper connection layer 340 may surround the side surface of the optical integrated circuit chip 350 and the side surface of a photonic integrated circuit (PIC) insulating layer 3592. The molding layer 360 may include, for example, an EMC.

A PIC connection layer 359 may be disposed below the optical integrated circuit chip 350. The PIC connection layer 359 may correspond to the lower surface of the optical integrated circuit chip 350 in a plan view, and the PIC connection layer 359 may extend along the lower surface of the optical integrated circuit chip 350. The PIC connection layer 359 may include the PIC insulating layer 3592 and a PIC connection pad 3594a. As illustrated in FIG. 2, the PIC connection layer 359 includes an alternating series of the PIC insulating layer 3592 and the PIC connection pad 3594a.

The PIC insulating layer 3592 may extend, at a constant thickness, along the lower surface of the optical integrated circuit chip 350. However, as understood by one of ordinary skill in the art, the embodiments are not limited to these configurations, and the thickness along the lower surface of the integrated circuit chip 350 may vary (e.g., tapering towards edge of integrated circuit chip 350). In one or more examples, since the material of the PIC insulating layer 3592 is substantially the same as the material of the lower insulating layer 322, a detailed description thereof is omitted below.

In a plan view, the outer perimeter of the PIC insulating layer 3592 may correspond to the outer perimeter of the optical integrated circuit chip 350.

The side surfaces of the PIC connection pad 3594a may be surrounded by the PIC insulating layer 3592.

The PIC connection pad 3594a may be located inside the PIC insulating layer 3592. In this case, the vertical length of the PIC connection pad 3594a is the same as the vertical length of the PIC insulating layer 3592. In one or more examples, the PIC connection pad 3594a may be exposed through the upper surface of the PIC insulating layer 3592 and also exposed through the lower surface of the PIC insulating layer 3592. A plurality of PIC connection pads 3594a may serve as connection terminals between the optical integrated circuit chip 350 and the upper connection layer 340. Since the material of the PIC connection pad 3594a is substantially the same as the material of the lower pad 324, a detailed description thereof is omitted below.

According to one or more embodiments, a length H2 of the optical integrated circuit chip 350 in the vertical direction (the Z direction) may be greater than a length H1 of the electronic integrated circuit chip 310 in the vertical direction (the Z direction). Since the optical integrated circuit chip 350 is disposed above the electronic integrated circuit chip 310, the electronic integrated circuit chip 310 includes a through-electrode, whereas the optical integrated circuit chip 350 does not include a through-electrode. Since the optical integrated circuit chip 350 does not include a through-electrode, the length of the optical integrated circuit chip 350 in the vertical direction (the Z direction) may be greater than the length of the electronic integrated circuit chip 310 in the vertical direction (the Z direction). Since the length of the optical integrated circuit chip 350 in the vertical direction (the Z direction) is formed to be large, the structural stability of the optical integrated circuit chip 350 may be improved.

According to one or more embodiments, the length H1 of the electronic integrated circuit chip 310 in the vertical direction (the Z direction) may be in a range of about 10 micrometers to about 50 micrometers. In one or more examples, the length H2 of the optical integrated circuit chip 350 in the vertical direction (the Z direction) may be greater than 600 micrometers. For convenience of illustration and description, the length of the electronic integrated circuit chip 310 in the vertical direction (the Z direction) is shown herein to be not significantly different from the length of the optical integrated circuit chip 350 in the vertical direction (the Z direction). However, the length of the optical integrated circuit chip 350 in the vertical direction (the Z direction) may be at least 12 times the length of the electronic integrated circuit chip 310 in the vertical direction (the Z direction).

According to one or more embodiments, the semiconductor package 10 of FIG. 1 may communicate with an external device by using an optical signal via the photonic chip structure 300a. The photonic chip structure 300a may receive an optical signal from an external device, convert the received optical signal into an electrical signal, and input the electrical signal into the first chip structure 400 and the second chip structure 500 via the interposer 200.

The optical integrated circuit chip 350 may convert an optical signal received via a lens into an electric signal by using an optical component and convert the electric signal into an optical signal. The optical component may include a photodetector, a photodiode, a modulator, or the like.

During a process of inputting an optical signal into the photonic chip structure 300a, the photodetector may detect the optical signal input into the optical integrated circuit chip 350. The optical integrated circuit chip 350 may detect an optical signal input via the photodetector and convert the detected optical signal into the electric signal.

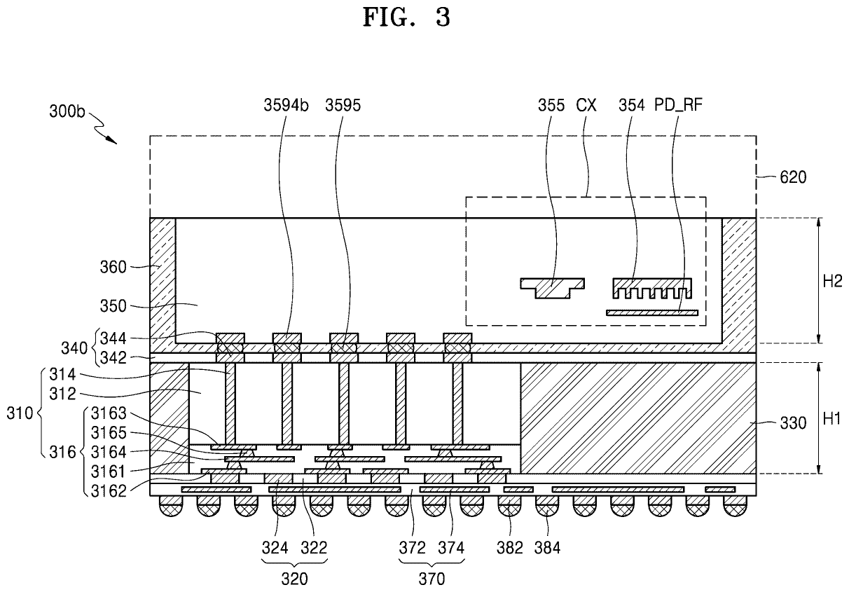

FIG. 3 is a cross-sectional view of a photonic chip structure 300b according to another embodiment.

The photonic chip structure 300b illustrated in FIG. 3 is almost identical or similar to the photonic chip structure 300a illustrated in FIG. 2, except that an optical integrated circuit chip 350 of the photonic chip structure 300b is connected to an upper connection layer 340 via a micro bump 3595 instead of the PIC connection layer 359 of FIG. 2. Therefore, descriptions of the components already given above with reference to FIG. 2 are omitted or briefly given below.

According to one or more embodiments, the photonic chip structure 300b may include the micro bump 3595 for physically and electrically connecting the optical integrated circuit chip 350 to the upper connection layer 340.

PIC connection pads 3594b of the photonic chip structure 300b illustrated in FIG. 3 may be buried in the optical integrated circuit chip 350 and arranged along the lower surface of the optical integrated circuit chip 350. The PIC connection pads 3594b may be exposed through the lower surface of the optical integrated circuit chip 350.

The micro bump 3595 may include a terminal for physically and electrically connecting the PIC connection pad 3594b of the optical integrated circuit chip 350 to the upper pad 344 of the upper connection layer 340. The micro bump 3595 may be in contact with the lower surface of the PIC connection pad 3594b and the upper surface of the upper pad 344. In one or more embodiments, the micro bump 3595 may include a solder of a metal material including at least one of tin (Sn), silver (Ag), copper (Cu), and aluminum (Al).

FIG. 4 is an enlarged view of region “CX” of FIG. 3. A description is given below with reference to FIGS. 1 and 4.

Referring to FIG. 4, the optical integrated circuit chip 350 may include a first semiconductor layer 351, a photodetector 352, a modulator 353, a grating coupler 354, a rib waveguide 355, a channel waveguide 356, an oxide layer 357, a passivation layer 358, first to sixth pads PD1 to PD6, first to eighth vias VA1 to VA8, first and second wide vias WVA1 and WVA2, an anti-reflection layer ARF, a reflective pad PD_RF, a dielectric layer DL, and a lens LEN.

The first semiconductor layer 351 may have a constant thickness on the lower surface of the anti-reflection layer ARF. The first semiconductor layer 351 may include silicon (Si). The first semiconductor layer 351 may provide an optical passage through which optical signals incident via the lens LEN pass.

The oxide layer 357 may be disposed below the first semiconductor layer 351. The oxide layer 357 may have a relatively greater thickness than the first semiconductor layer 351. The oxide layer 357 may include an insulating layer in which a plurality of optical devices (e.g., the photodetector 352, the modulator 353, the grating coupler 354, the rib waveguide 355, and the channel waveguide 356) are buried. For example, the oxide layer 357 may include silicon oxide. The oxide layer 357 may extend along the lower surface of the first semiconductor layer 351.

According to one or more embodiments, the photodetector 352 may be configured to convert an optical signal received via the lens LEN into an electrical signal. The photodetector 352 may include a photodetector substrate 3521, a source drain region 3522, and an absorbent layer 3523.

The photodetector substrate 3521 may include a base structure made of a material, such as silicon. In some embodiments, the base structure may include a complementary metal-oxide semiconductor (CMOS). The photodetector substrate 3521 may include a semiconductor material, for example, a group IV semiconductor, a group III-V compound semiconductor, or a group II-VI oxide semiconductor. For example, the group IV semiconductor may include silicon (Si), germanium (Ge), or silicon-germanium. The photodetector substrate 3521 may be provided as a bulk wafer or epitaxial layer. According to one or more embodiments, the photodetector substrate 3521 may be defined as an active region, and the active region may include a region doped with impurities.

The source drain region 3522 may include doped regions that are formed on the photodetector substrate 3521 with the absorbent layer 3523 therebetween. In this case, the source drain region 3522 may include regions doped with impurities of the opposite conductivity type to the active region of the photodetector substrate 3521. In some embodiments, the active region of the photodetector substrate 3521 may include a region doped with p-type impurities, and the source drain region 3522 may include a region doped with n-type impurities. In another embodiment, contrary to the above configuration, the active region of the photodetector substrate 3521 may include a region doped with n-type impurities, and the source drain region 3522 may include a region doped with p-type impurities.

The absorbent layer 3523 may immediately absorb an optical signal incident via the lens LEN. The absorbent layer 3523 may include, for example, germanium (Ge).

The modulator 353 may be configured to convert an electrical signal into an optical signal. The modulator 353 may include a semiconductor material, such as silicon (Si). According to one or more embodiments, the modulator 353 may include first to sixth doping regions 3531 to 3536. The first doping region 3531 and the sixth doping region 3536 may be located at the outermost sides of the modulator 353. In one or more examples, the third doping region 3533 and the fourth doping region 3534 may be located in central regions of the modulator 353. The second doping region 3532 may be located between the first doping region 3531 and the third doping region 3533, and the fifth doping region 3535 may be located between the fourth doping region 3534 and the sixth doping region 3536.

According to one or more embodiments, the first to third doping regions 3531 to 3533 may include regions doped with n-type impurities, and the fourth to sixth doping regions 3534 to 3536 may include regions doped with p-type impurities. The second doping region 3532 may have a higher concentration of n-type impurities than the third doping region 3533, and the first doping region 3531 may have a higher concentration of n-type impurities than the second doping region 3532. The fifth doping region 3535 may have a higher concentration of p-type impurities than the fourth doping region 3534, and the sixth doping region 3536 may have a higher concentration of p-type impurities than the fifth doping region 3535.

According to one or more embodiments, the grating coupler 354 may be located inside the oxide layer 357. The grating coupler 354 may be configured to couple an optical signal that is incident on the first semiconductor layer 351 via the lens LEN. Specifically, an optical signal that reaches the grating coupler 354 via the first semiconductor layer 351 may be coupled to another waveguide. The grating coupler 354 may include a semiconductor material, such as silicon (Si). In one or more examples, the grating coupler 354 may be a structure that couples light between a waveguide and a free-space wave, or between a fiber and a chip. The grating coupler 354 may be formed by etching a refractive index modulation into a thin layer on a waveguide's surface, where index variation creates a diffraction effect that couples light into the waveguide.

According to one or more embodiments, the rib waveguide 355 and the channel waveguide 356 may be arranged in the oxide layer 357. The rib waveguide 355 may provide a passage through which an optical signal travels, and may have a downwardly protruding center. The channel waveguide 356 may have a rectangular parallelepiped shape. The rib waveguide 355 and the channel waveguide 356 may each include a semiconductor material, such as silicon (Si).

The passivation layer 358 may be disposed below the oxide layer 357 in the vertical direction (the Z direction). The passivation layer 358 may include a flat portion 3581 extending along the lower surface of the oxide layer 357 and a trench portion 3582 protruding toward the oxide layer 357 and inserted therein. The passivation layer 358 may include silicon oxide (SiO), silicon nitride (SiN), silicon oxynitride (SiON), silicon carbonitride (SiCN), or a combination thereof. Alternatively, the passivation layer 358 may include an insulating coating film including epoxy resin.

According to one or more embodiments, the reflective pad PD_RF may be located inside the oxide layer 357. The reflective pad PD_RF may be located below the grating coupler 354 in the vertical direction (the Z direction). In this case, the grating coupler 354 may overlap the reflective pad PD_RF in the vertical direction (the Z direction). The reflective pad PD_RF may reflect optical signals that do not reach the grating coupler 354 or are transmitted via the grating coupler 354 among the optical signals that are incident via the lens LEN and transmitted via the first semiconductor layer 351 so that the reflected optical signals reach the grating coupler 354. Conversely, the reflective pad PD_RF may reflect optical signals that do not reach the grating coupler 354 or are reflected from the grating coupler 354 and deviate from a path among the optical signals that travel from the waveguide to the grating coupler 354 so that the reflected optical signals reach the grating coupler 354.

In one or more embodiments, the material of the reflective pad PD_RF may include a metal, such as silver (Ag), gold (Au), copper (Cu), and aluminum (Al), or an alloy thereof. In this case, the reflective pad PD_RF may include a material configured to reflect more than 70% of optical signals having a wavelength of 0.6 micrometers or more.

According to one or more embodiments, the dielectric layer DL may surround the outer surface of the reflective pad PD_RF. The outer surface of the reflective pad PD_RF may be conformally coated with the dielectric layer DL. The outer surface of the reflective pad PD_RF is coated with the dielectric layer DL, and thus, the occurrence of an electrical short circuit between the reflective pad PD_RF and the first to sixth pads PD1 to PD6 may be prevented. For example, the dielectric layer DL may include silicon oxide (SiO), silicon nitride (SiN), silicon oxynitride (SiON), silicon carbonitride (SiCN), or a combination thereof.

According to one or more embodiments, a shortest distance H3 in the vertical direction (the Z direction) between the reflective pad PD_RF and the grating coupler 354 may be in a range of about 0.5 micrometers to about 5 micrometers.

According to one or more embodiments, the photodetector 352 and the modulator 353 may be electrically connected to a conductive via and a conductive pad. Through the conductive via and the conductive pad, the photodetector 352 and the modulator 353 may be electrically connected to the PIC connection pads 3594a and 3594b illustrated in FIGS. 2 and 3. The conductive pad may be bonded directly or indirectly to the PIC connection pads.

First to eighth vias VA1 to VA8 may each have a tapered shape of which the diameter decreases toward the first semiconductor layer 351 from the passivation layer 358. According to one or more embodiments, the first via VA1 may be electrically and physically connected to the absorbent layer 3523 of the photodetector 352. The second via VA2 may be electrically and physically connected to one of a pair of source drain regions 3522 of the photodetector 352.

The first pad PD1 may be in contact with the lower surface of the first via VA1 and the second pad PD2 may be in contact with the lower surface of the second via VA2.

The third via VA3 may overlap the modulator 353 in the vertical direction (the Z direction), and the fourth via VA4 may be electrically and physically connected to the sixth doping region 3536 of the modulator 353.

The third pad PD3 may be in contact with the lower surface of the third via VA3 and the fourth pad PD4 may be in contact with the lower surface of the fourth via VA4.

The fifth via VA5 may be in contact with the lower surface of the first pad PD1 and the sixth via VA6 may be in contact with the lower surface of the second pad PD2. The seventh via VA7 may be in contact with the lower surface of the third pad PD3 and the eighth via VA8 may be in contact with the lower surface of the fourth pad PD4.

The fifth pad PD5 may be in contact with both the lower surface of the fifth via VA5 and the lower surface of the sixth via VA6, and the sixth pad PD6 may be in contact with both the lower surface of the seventh via VA7 and the lower surface of the eighth via VA8.

The first wide via WVA1 may be in contact with the lower surface of the fifth pad PD5, and the second wide via WVA2 may be in contact with the lower surface of the sixth pad PD6.

According to one or more embodiments, the materials of the first to eighth vias VA1 to VA8, the first to sixth pads PD1 to PD6, and the first and second wide vias WVA1 and WVA2 may include metals, such as nickel (Ni), copper (Cu), gold (Au), silver (Ag), tungsten (W), titanium (Ti), tantalum (Ta), indium (In), molybdenum (Mo), manganese (Mn), cobalt (Co), tin (Sn), magnesium (Mg), rhenium (Re), beryllium (Be), gallium (Ga), and ruthenium (Ru), or alloys thereof. However, the materials constituting the first to eighth vias VA1 to VA8 may be different from the materials constituting the first to sixth pads PD1 to PD6 and the first and second wide vias WVA1 and WVA2.

According to one or more embodiments, the anti-reflection layer ARF may be conformally formed on the upper surface of the first semiconductor layer 351.

The anti-reflection layer ARF may include silicon oxide, silicon nitride, titanium oxide, aluminum oxide, magnesium fluoride, or a combination thereof. The anti-reflection layer ARF may prevent the total reflection of light when the light is incident on the optical integrated circuit chip 350 from the outside.

The lens LEN may be located on the anti-reflection layer ARF. Herein, the lens LEN may include a micro lens.

According to one or more embodiments, first incident light IL1 is first incident on the first semiconductor layer 351 via the lens LEN. Subsequently, the first incident light IL1 incident on the first semiconductor layer 351 passes through the first semiconductor layer 351 and reaches the grating coupler 354 buried in the oxide layer 357. The first incident light IL1 reaching the grating coupler 354 may be coupled to the waveguide (e.g., the rib waveguide 355 or the channel waveguide 356) buried in the oxide layer 357.

According to one or more embodiments, unlike the first incident light IL1, second incident light IL2 represents light that does not reach the grating coupler 354 via the first semiconductor layer 351. First, the second incident light IL2 is incident on the first semiconductor layer 351 via the lens LEN. Subsequently, the second incident light IL2 incident on the first semiconductor layer 351 passes through the first semiconductor layer 351 and then fails to reach the grating coupler 354 or passes through the grating coupler 354. The second incident light IL2 that does not reach the grating coupler 354 or passes through the grating coupler 354 is reflected by the reflective pad PD_RF and reaches the grating coupler 354. The second incident light IL2 reflected by the reflective pad PD_RF and reaching the grating coupler 354 may be coupled to the waveguide (e.g., the rib waveguide 355 or the channel waveguide 356) buried in the oxide layer 357.

According to one or more embodiments, first emission light OL1 may be first coupled to the grating coupler 354 from the waveguide (e.g., the rib waveguide 355 or the channel waveguide 356) buried in the oxide layer 357. Subsequently, the coupled first emission light OL1 may be incident on the first semiconductor layer 351 and then emitted to the outside via the lens LEN.

According to one or more embodiments, unlike the first emission light OL1, second emission light OL2 represents light that does not reach the grating coupler 354. First, the second emission light OL2 is refracted from the grating coupler 354 and reaches the reflective pad PD_RF. Subsequently, the second emission light OL2 reflected by the reflective pad PD_RF may reach the grating coupler 354 and be coupled thereto. Subsequently, the coupled second emission light OL2 may be incident on the first semiconductor layer 351 and then emitted to the outside via the lens LEN.

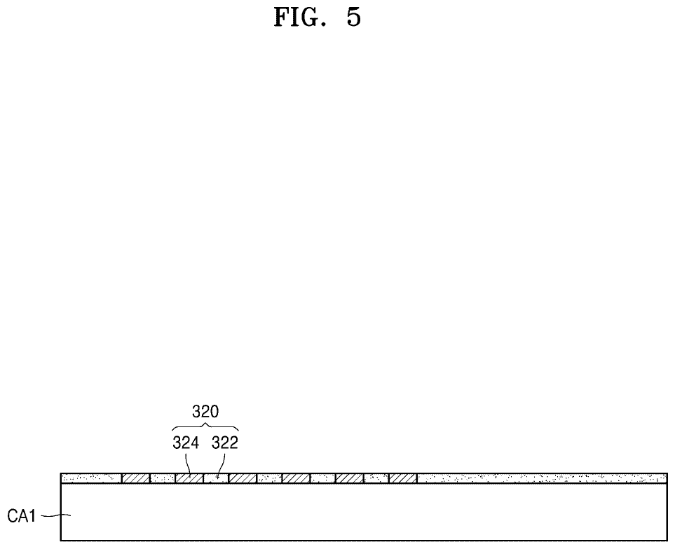

FIGS. 5 to 13 are cross-sectional views illustrating a manufacturing process of the photonic chip structure 300a, according to one or more embodiments.

Referring to FIG. 5, first, a lower connection layer 320 may be formed on a first carrier substrate CA1. To form the lower connection layer 320, an insulating material may be formed first on the first carrier substrate CA1 using a deposition process. The deposition process may be at least one of a physical vapor deposition (PVD) process, a chemical vapor deposition (CVD) process, and an atomic layer deposition (ALD) process. The CVD process may include deposition processes, such as plasma-enhanced chemical vapor deposition (PECVD) and high density plasma chemical vapor deposition (HDPCVD).

Subsequently, a lower pad 324 buried in the lower connection layer 320 may be formed. The lower pad 324 may be formed through a plating process or the like.

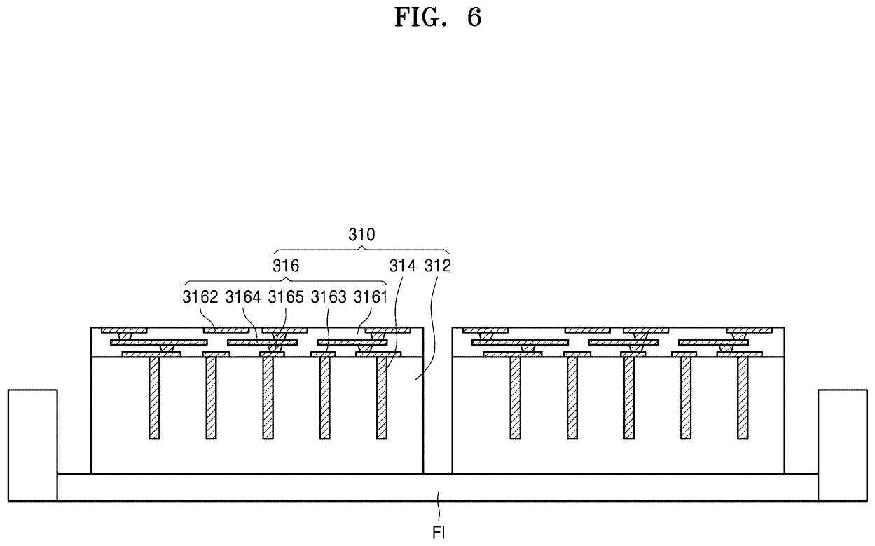

Referring to FIG. 6, an electronic integrated circuit chip 310 may be formed on an adhesive film FI. First, a first substrate 312 is formed on the adhesive film FI, and then an EIC wiring portion 316 is formed on the first substrate 312. Herein, an EIC through-electrode 314 that at least partially passes through the first substrate 312 in a vertical direction (a Z direction) may be formed inside the first substrate 312.

To form the EIC wiring portion 316, an EIC insulating layer 3161 may be deposited first on the first substrate 312. In a plan view, the perimeter of the EIC insulating layer 3161 may correspond to the perimeter of the first substrate 312. An EIC upper pad 3163 is formed on the EIC through-electrode 314 inside the first substrate 312. The EIC upper pad 3163 may be aligned with the EIC through-electrode 314 and in contact with the upper surface of the EIC through-electrode 314.

Subsequently, an EIC conductive via 3165 aligned with the EIC upper pad 3163 may be formed. The EIC conductive via 3165 may have a tapered shape of which the diameter decreases toward the EIC upper pad 3163 in the vertical direction (the Z direction) inside the EIC insulating layer 3161.

Subsequently, an EIC conductive pattern 3164 aligned with the upper surface of the EIC conductive via 3165 may be formed. The EIC conductive pattern 3164 may extend in lateral directions (the X direction and/or the Y direction) inside the EIC insulating layer 3161.

Subsequently, EIC conductive vias 3165 and the EIC conductive patterns 3164 are repeatedly formed, and then, an EIC lower pad 3162 aligned with the upper surface of the uppermost EIC conductive via 3165 may be formed. The EIC upper pad 3163, the EIC conductive via 3165, the EIC conductive pattern 3164, and the EIC lower pad 3162 may be formed by a plating process.

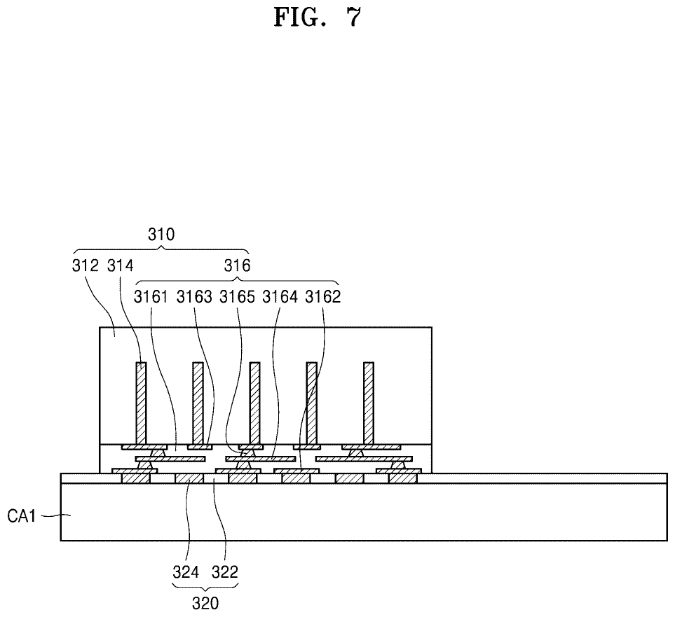

Referring to FIG. 7, the electronic integrated circuit chip 310 may be separated from the adhesive film FI illustrated in FIG. 6 and mounted on the lower connection layer 320 on the first carrier substrate CA1. Herein, the electronic integrated circuit chip 310 may be positioned such that the EIC lower pad 3162 of the EIC wiring portion 316 is aligned with the lower pad 324 of the lower connection layer 320. Since the completed electronic integrated circuit chip 310 is mounted on the lower connection layer 320, only a qualified electronic integrated circuit chip 310 may be selected and mounted on the lower connection layer 320.

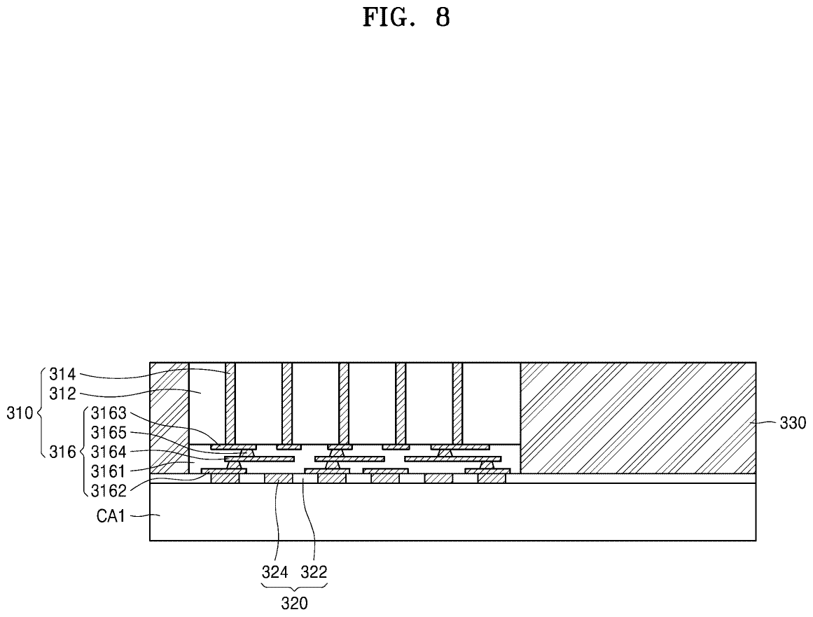

Referring to FIG. 8, an outer insulating layer 330 may be formed on the lower connection layer 320. For example, an insulating material may be applied to the upper surface of the lower connection layer 320 so that the electronic integrated circuit chip 310 is buried therein, and then, the insulating material may be cured. Herein, the insulating material may include, for example, an EMC material. After the insulating material is applied to the upper surface of the lower connection layer 320, an upper end portion of the insulating material and an upper end portion of the electronic integrated circuit chip 310 may be removed through a planarization process. The outer insulating layer 330 may be completed by removing the upper end portion of the insulating material. In one or more examples, as the upper end portion of the electronic integrated circuit chip 310 is removed, the EIC through-electrode 314 may be exposed through the upper surface of the first substrate 312.

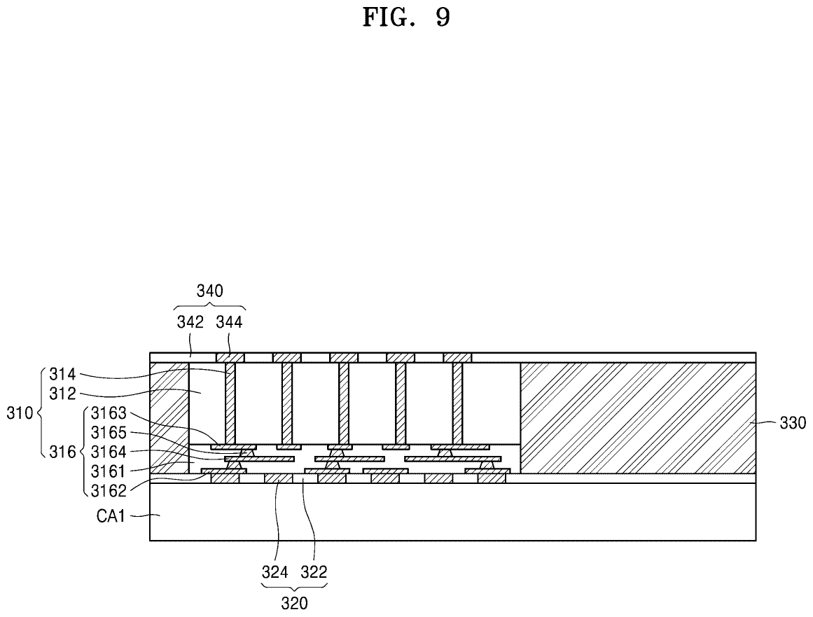

Referring to FIG. 9, an upper connection layer 340 may be formed on the outer insulating layer 330 and the first substrate 312. To form the upper connection layer 340, an insulating material may be deposited first on the outer insulating layer 330 and the first substrate 312 using a deposition process. The deposition process may be at least one of a PVD process, a CVD process, and an ALD process.

Subsequently, an upper pad 344 buried in the upper connection layer 340 may be formed. The upper pad 344 may be formed through a plating process or the like. The upper pad 344 may overlap the EIC through-electrode 314.

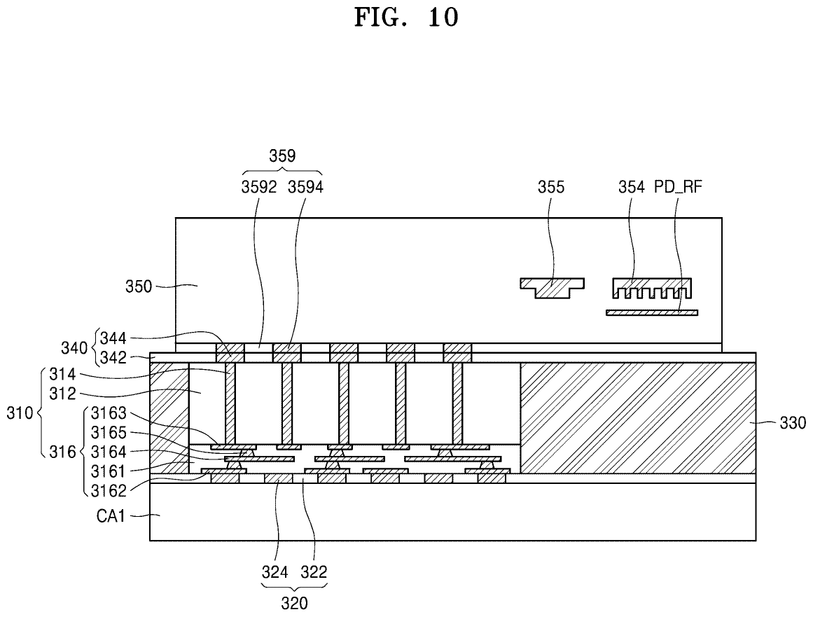

Referring to FIG. 10, an optical integrated circuit chip 350 may be then mounted on the upper connection layer 340. Since the completed optical integrated circuit chip 350 is mounted on the upper connection layer 340, only a qualified optical integrated circuit chip 350 may be selected and mounted above the electronic integrated circuit chip 310. The optical integrated circuit chip 350 may include a grating coupler 354, a rib waveguide 355, and a reflective pad PD_RF.

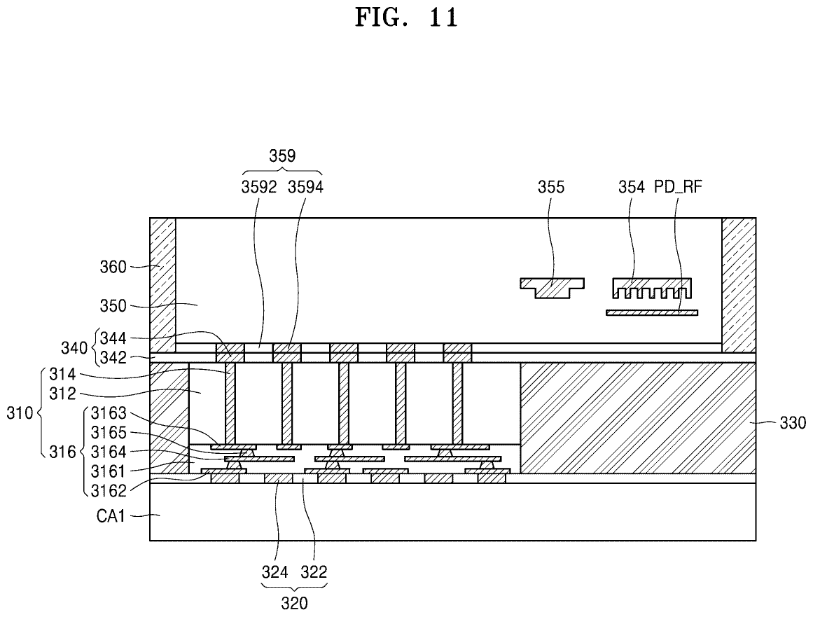

Referring to FIG. 11, a molding layer 360 may be formed on the upper connection layer 340. For example, an insulating material may be applied to the upper surface of the upper connection layer 340 so that the optical integrated circuit chip 350 is buried therein, and then, the insulating material may be cured. Herein, the insulating material may include, for example, an EMC material. After the insulating material is applied to the upper surface of the lower connection layer 320, an upper end portion of the insulating material and an upper end portion of the optical integrated circuit chip 350 may be removed through a planarization process. The molding layer 360 may be completed by removing the upper end portion of the insulating material.

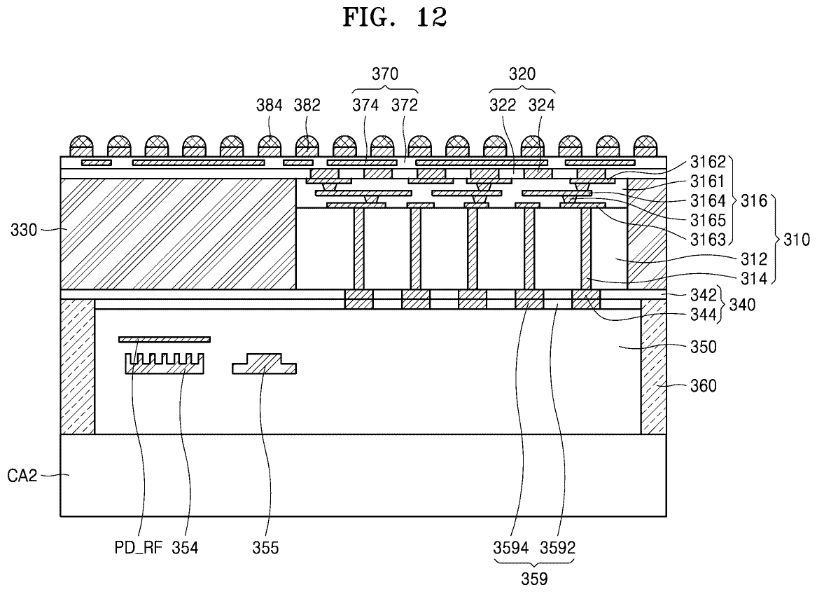

Referring to FIG. 12, the first carrier substrate CA1 is removed, and then, the result of FIG. 11 may be turned over so that the lower surface of the lower connection layer 320 faces upward. After the result of FIG. 11 is turned over, a redistribution structure 370 may be formed on the lower surface of the lower connection layer 320. To form the redistribution structure 370, an insulating material may be deposited first on the lower insulating layer 322 using a deposition process. The deposition process may be at least one of a PVD process, a CVD process, and an ALD process.

Subsequently, a redistribution pattern layer 374 is formed on the lower insulating layer 322 through a plating process. An insulating material is deposited such that the redistribution pattern layer 374 is buried therein, and accordingly, a redistribution insulating layer 372 is formed. As the processes described above are repeated, the redistribution structure 370 may be formed.

After the redistribution structure 370 is formed, a photonic chip pad 382 and a photonic chip bump 384 may be formed on the redistribution structure 370. The photonic chip pad 382 may be formed on the upward-facing surface of the redistribution structure 370. Subsequently, the photonic chip bump 384 may be attached on the photonic chip pad 382.

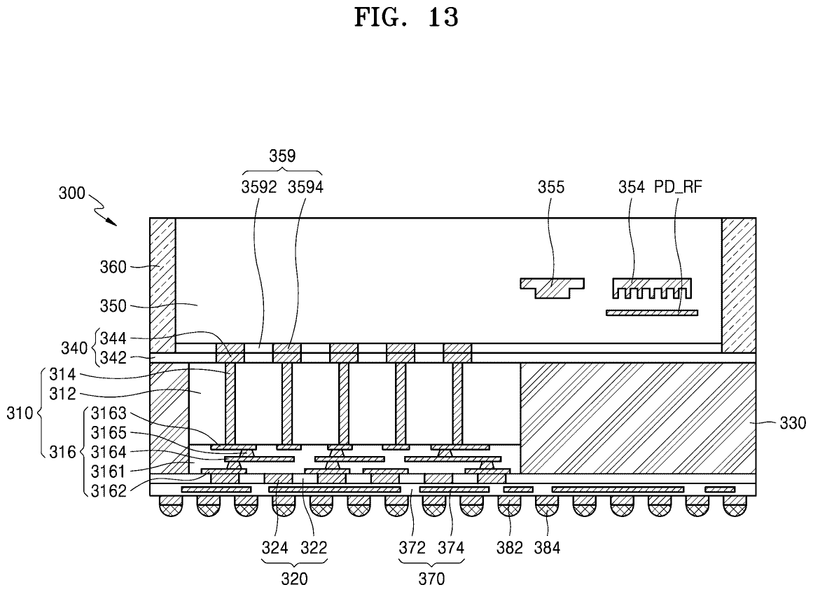

Referring to FIG. 13, after a second carrier substrate CA2 is removed, the result of FIG. 12 may be turned over to complete the photonic chip structure 300a.

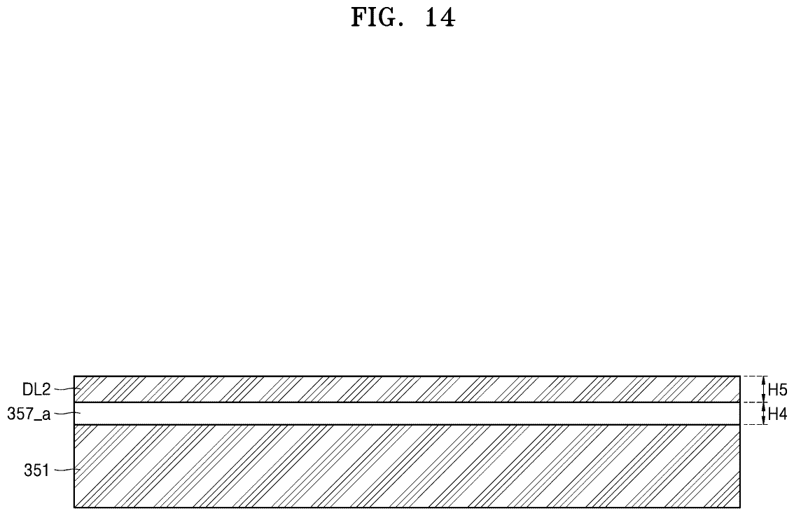

FIGS. 14 to 27 are cross-sectional views illustrating a manufacturing process of an optical integrated circuit chip 350, according to one or more embodiments.

Referring to FIG. 14, a first oxide layer 357_a may be formed first on a first semiconductor layer 351. The first oxide layer 357_a may be deposited so as to extend along the upper surface of the first semiconductor layer 351. After the first oxide layer 357_a is formed on the first semiconductor layer 351, a second dielectric layer DL2 may be formed. The second dielectric layer DL2 may be deposited so as to extend along the upper surface of the first oxide layer 357_a. According to one or more embodiments, the first semiconductor layer 351 and the second dielectric layer DL2 may each include a semiconductor material, such as silicon (Si).

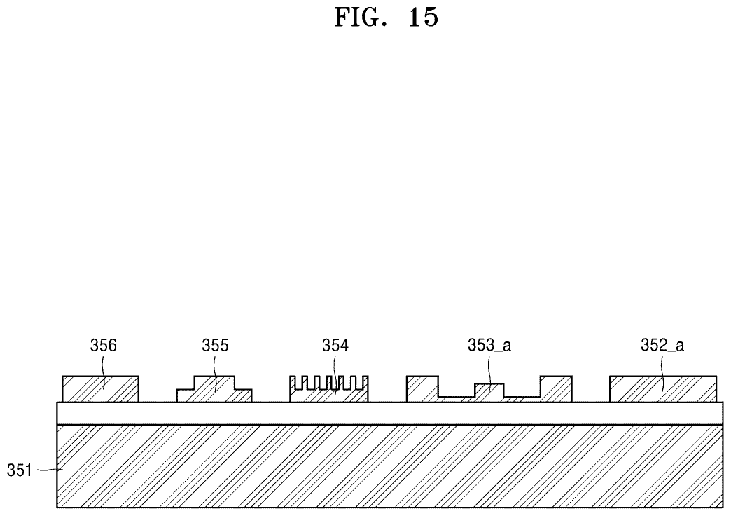

Referring to FIG. 15, a photodetector body 352_a, a modulator body 353_a, a grating coupler 354, a rib waveguide 355, and a channel waveguide 356 may be formed through a lithography process on the second dielectric layer DL2. The photodetector body 352_a and the modulator body 353_a mentioned herein represent members for which a doping process and a lithography process have not been completed.

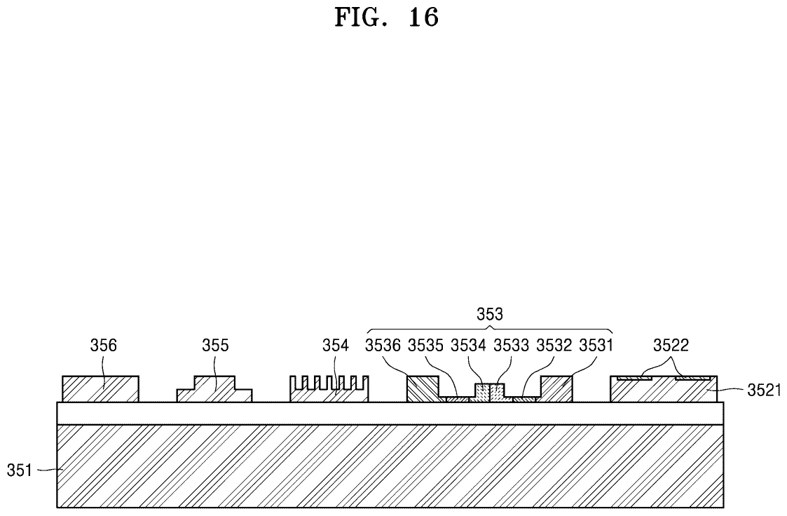

Referring to FIG. 16, the doping process may be performed on the photodetector body 352_a and the modulator body 353_a. First, the photodetector body 352_a is doped with p-type impurities to form a photodetector substrate 3521. Subsequently, the upper surface of the photodetector substrate 3521 is partially doped with n-type impurities to form a pair of source drain regions 3522.

Subsequently, the modulator body 353_a is doped with p-type impurities and n-type impurities to form first to sixth doping regions 3531 to 3536. The first to third doping regions 3531 to 3533 may include regions doped with n-type impurities, and the fourth to sixth doping regions 3534 to 3536 may include regions doped with p-type impurities. The second doping region 3532 may have a higher concentration of n-type impurities than the third doping region 3533, and the first doping region 3531 may have a higher concentration of n-type impurities than the second doping region 3532. The fifth doping region 3535 may have a higher concentration of p-type impurities than the fourth doping region 3534, and the sixth doping region 3536 may have a higher concentration of p-type impurities than the fifth doping region 3535.

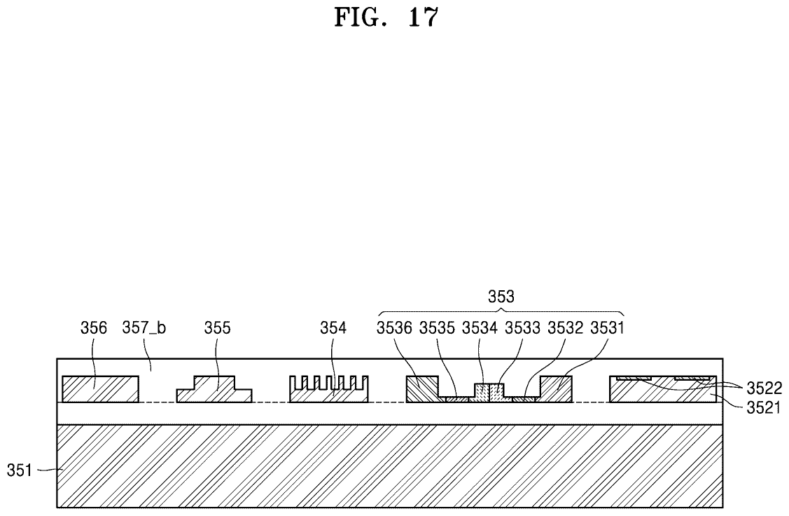

Referring to FIG. 17, a second oxide layer 357_b may be deposited on the first oxide layer 357_a so that the photodetector substrate 3521, the modulator 353, the grating coupler 354, the rib waveguide 355, and the channel waveguide 356 are buried therein. The process of depositing the second oxide layer 357_b may be similar to the process of depositing the first oxide layer 357_a. When depositing the second oxide layer 357_b, the interface between the first oxide layer 357_a and the second oxide layer 357_b may disappear.

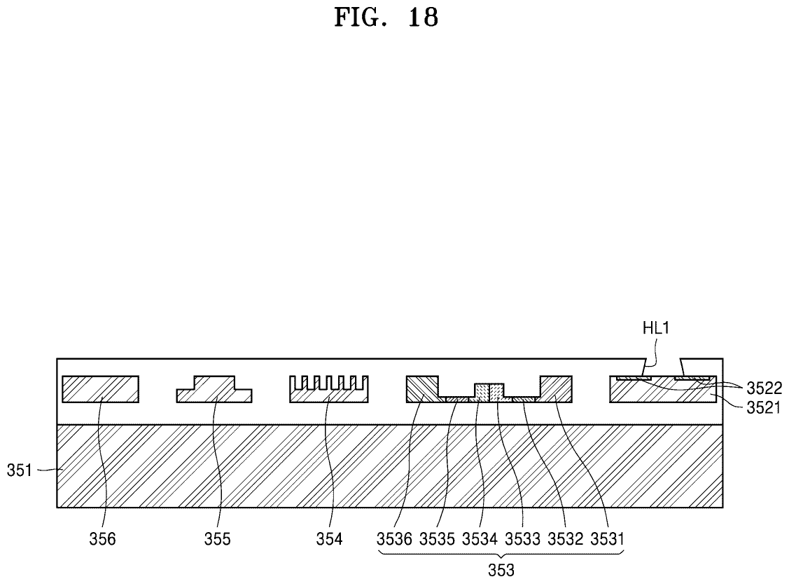

Subsequently, referring to FIG. 18, a first hole HL1 may be formed in the second oxide layer 357_b. Herein, the first hole HL1 may be formed by a dry etching process. As the first hole HL1 is formed in the second oxide layer 357_b, the upper surface of the photodetector substrate 3521 and the upper surface of the source drain region 3522 may be partially exposed. The width of the first hole HL1 may increase from the upper surface of the second oxide layer 357_b toward the photodetector substrate 3521.

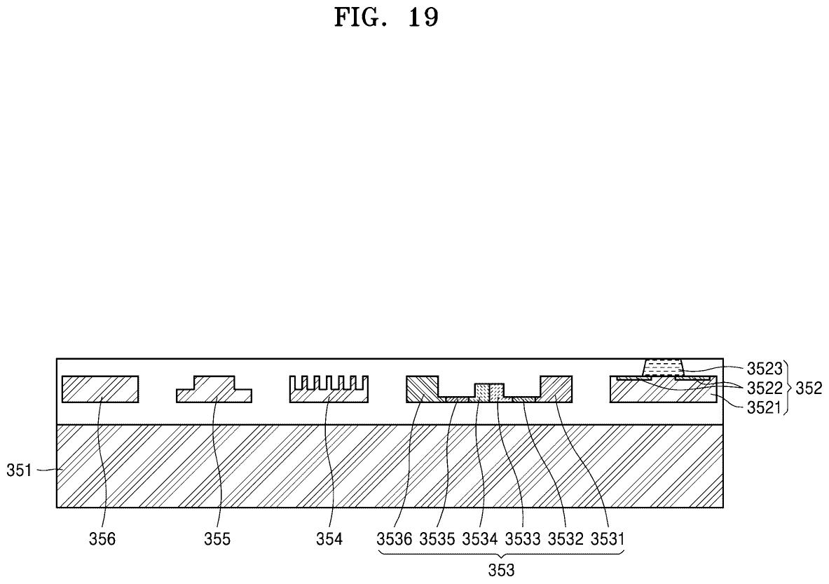

Referring to FIG. 19, a semiconductor material may be deposited in the first hole HL1 to form an absorbent layer 3523. Herein, the semiconductor material may include germanium (Ge). If necessary, a planarization process may be performed to planarize the upper surface of the absorbent layer 3523 and the upper surface of the second oxide layer 357_b.

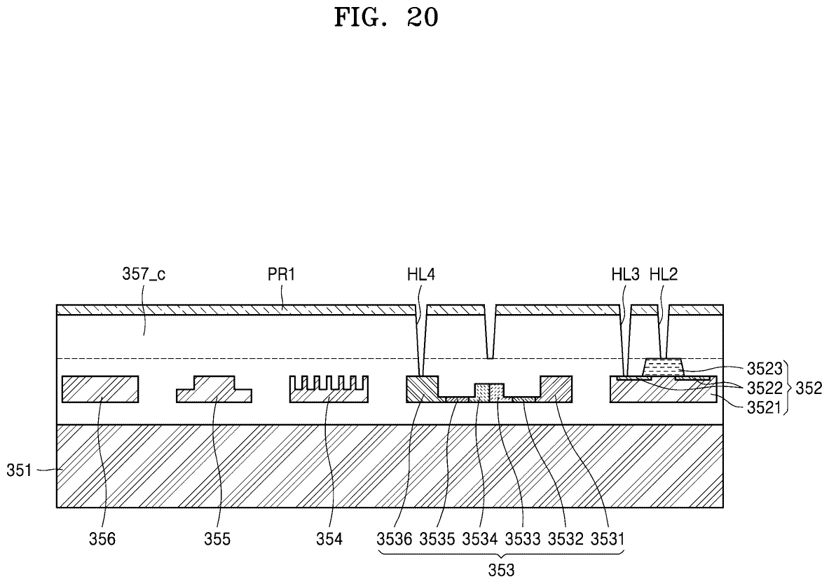

Referring to FIG. 20, a third oxide layer 357_c may be deposited on the second oxide layer 357_b. The process of depositing the third oxide layer 357_c may be similar to the process of depositing the first oxide layer 357_a. The third oxide layer 357_c may have a certain thickness on the second oxide layer 357_b. If necessary, a planarization process may be performed to planarize the upper surface of the third oxide layer 357_c. After the third oxide layer 357_c is formed, a first photoresist layer PR1 may be formed along the upper surface of the third oxide layer 357_c. The first photoresist layer PR1 may have a constant thickness along the upper surface of the third oxide layer 357_c.

For example, the first photoresist layer PR1 may include a photosensitive resin material that undergoes a chemical change when irradiated with light.

After the first photoresist layer PR1 is formed, a second hole HL2, a third hole HL3, and a fourth hole HL4 may be formed. The second to fourth holes HL2 to HL4 may be formed through the first photoresist layer PR1, the third oxide layer 357_c, and the second oxide layer 357_b (see FIG. 17). The second hole HL2 may extend to the absorbent layer 3523 of a photodetector 352. The absorbent layer 3523 of the photodetector 352 may be exposed through the second hole HL2. The third hole HL3 may extend to the source drain region 3522 of the photodetector 352. The source drain region 3522 of the photodetector 352 may be exposed through the third hole HL3. The fourth hole HL4 may extend to the sixth doping region 3536 of the modulator 353. The sixth doping region 3536 of the modulator 353 may be exposed through the fourth hole HL4. According to one or more embodiments, the second to fourth holes HL2 to HL4 may each have a tapered shape of which the diameter decreases toward the first semiconductor layer 351 in the first photoresist layer PR1.

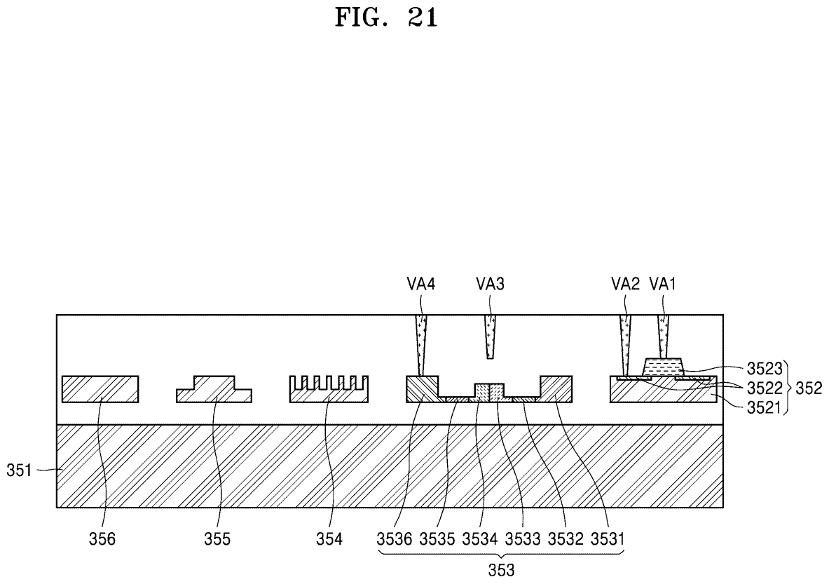

Referring to FIG. 21, the second to fourth holes HL2 to HL4 may be filled with conductive materials to form first to fourth vias VA1 to VA4. After the first to fourth vias VA1 to VA4 are formed, the first photoresist layer PR1 may be removed. The first via VA1 may extend to the absorbent layer 3523 of the photodetector 352. The second via VA2 may extend to the source drain region 3522 of the photodetector 352. The third via VA3 may overlap the modulator 353 in the vertical direction (the Z direction). The fourth via VA4 may extend to the sixth doping region 3536 of the modulator 353.

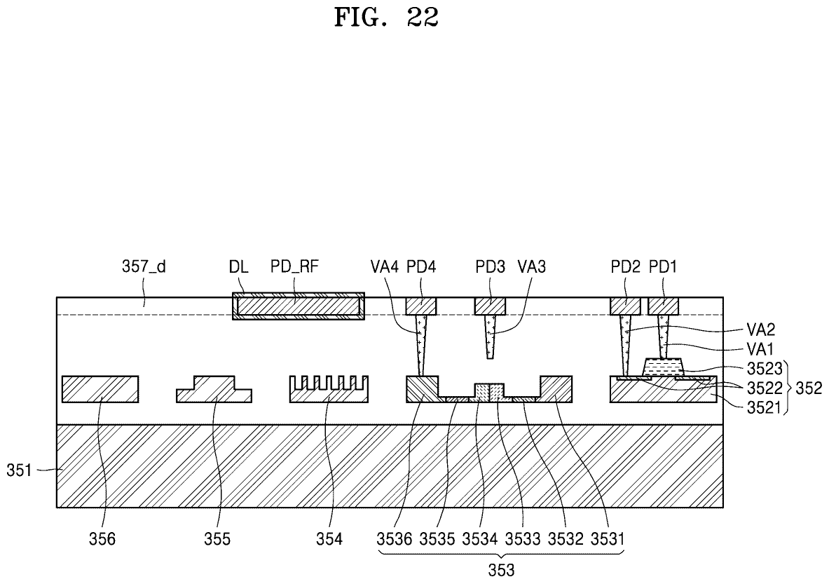

Referring to FIG. 22, a fourth oxide layer 357_d may be deposited on the third oxide layer 357_c. The process of depositing the fourth oxide layer 357_d may be similar to the process of depositing the first oxide layer 357_a. Subsequently, first to fourth pads PD1 to PD4 and the reflective pad PD_RF are buried in the fourth oxide layer 357_d. The first to fourth pads PD1 to PD4 and the reflective pad PD_RF may be formed through a plating process. The first pad PD1 may be formed on the upper surface of the first via VA1, and the second pad PD2 may be formed on the upper surface of the second via VA2. The third pad PD3 may be formed on the upper surface of the third via VA3, and the fourth pad PD4 may be formed on the upper surface of the fourth via VA4. In one or more examples, the reflective pad PD_RF may overlap the grating coupler 354 in the vertical direction (the Z direction). A dielectric layer DL may also be deposited along the perimeter of the reflective pad PD_RF. Herein, the process of forming the dielectric layer DL may use the ALD process.

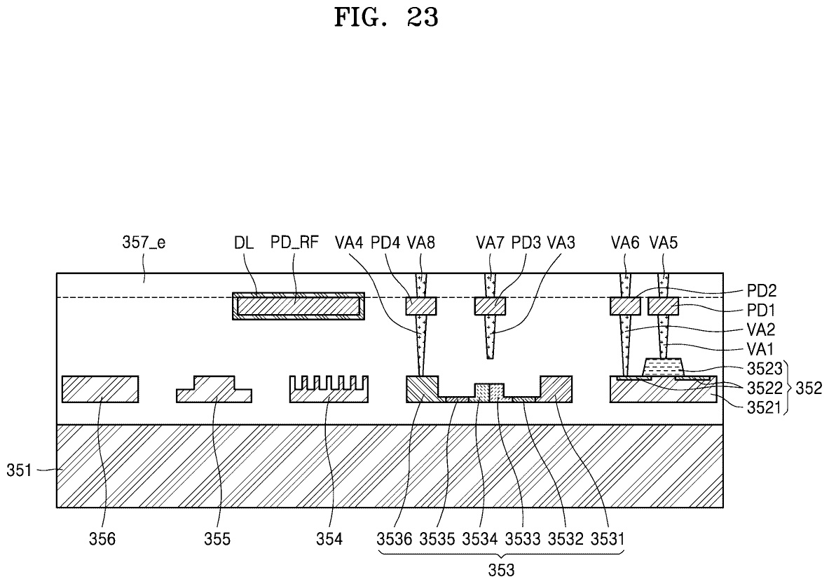

Referring to FIG. 23, a fifth oxide layer 357_e may be deposited on the fourth oxide layer 357_d. The process of depositing the fifth oxide layer 357_e may be similar to the process of depositing the first oxide layer 357_a. Subsequently, holes are formed in the fifth oxide layer 357_c, and the holes may be filled with conductive material to form fifth to eighth vias VA5 to VA8. The fifth via VA5 may extend to the first pad PD1 and the sixth via VA6 may extend to the second pad PD2. The seventh via VA7 may extend to the third pad PD3, and the eighth via VA8 may extend to the fourth pad PD4.

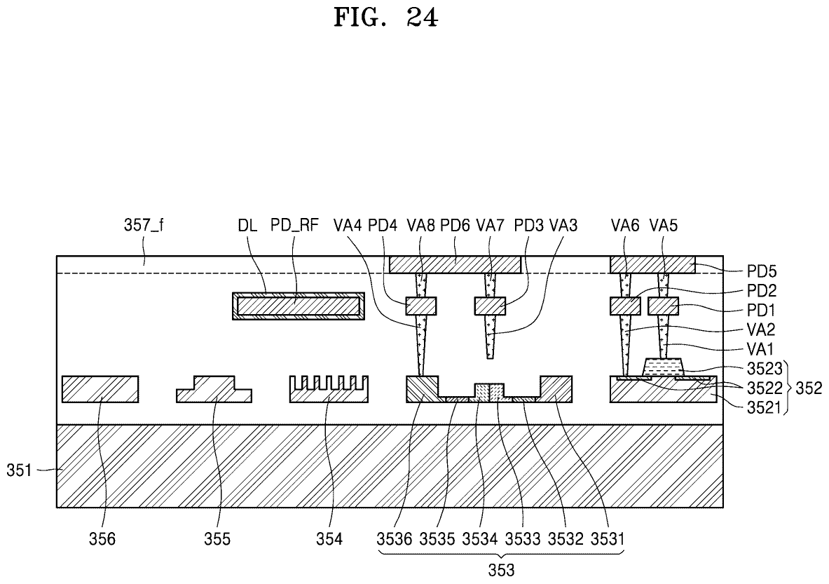

Referring to FIG. 24, a sixth oxide layer 357_f may be deposited on the fifth oxide layer 357_e. The process of depositing the sixth oxide layer 357_f may be similar to the process of depositing the first oxide layer 357_a. Subsequently, the fifth pad PD5 and the sixth pad PD6 may be buried in the sixth oxide layer 357_f. The fifth pad PD5 and the sixth pad PD6 may be formed through a plating process. The fifth pad PD5 may be formed on the upper surface of the fifth via VA5 and the upper surface of the sixth via VA6, and the sixth pad PD6 may be formed on the upper surface of the seventh via VA7 and the upper surface of the eighth via VA8. The fifth pad PD5 may be in contact with both the fifth via VA5 and the sixth via VA6, and the sixth pad PD6 may be in contact with both the seventh via VA7 and the eighth via VA8.

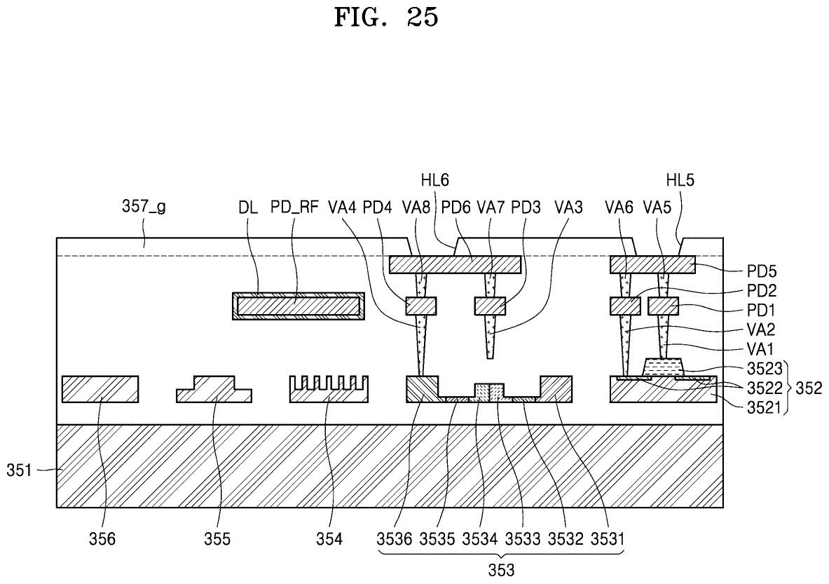

Referring to FIG. 25, a seventh oxide layer 357_g may be deposited on the sixth oxide layer 357_f. The process of depositing the seventh oxide layer 357_g may be similar to the process of depositing the first oxide layer 357_a. Subsequently, a fifth hole HL5 and a sixth hole HL6 may be formed in the seventh oxide layer 357_g. Herein, the fifth hole HL5 and the sixth hole HL6 may be formed by a dry etching process. As the fifth hole HL5 is formed in the seventh oxide layer 357_g, the upper surface of the fifth pad PD5 may be partially exposed. In one or more examples, as the sixth hole HL6 is formed in the seventh oxide layer 357_g, the upper surface of the sixth pad PD6 may be partially exposed. The widths of the fifth hole HL5 and the sixth hole HL6 may decrease from the upper surface of the seventh oxide layer 357_g toward to the first semiconductor layer 351. The oxide layer 357 of FIG. 4 may be completed by forming the seventh oxide layer 357_g.

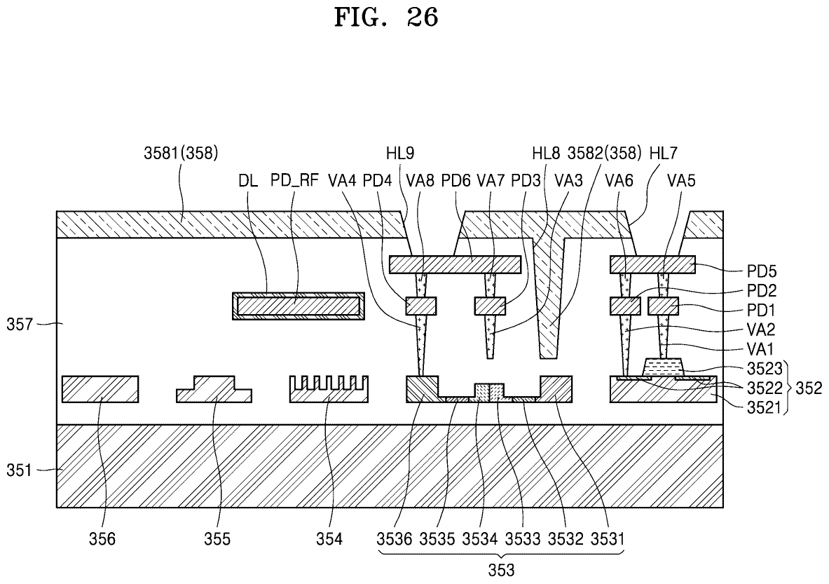

Referring to FIG. 26, a passivation layer 358 may be deposited on the oxide layer 357. The passivation layer 358 may include a flat portion 3581 and a trench portion 3582. The flat portion 3581 of the passivation layer 358 may extend along the upper surface of the oxide layer 357, and the trench portion 3582 of the passivation layer 358 may be formed by at least partially recessing the oxide layer 357. The width of the trench portion 3582 may decrease toward the first semiconductor layer 351. The passivation layer 358 may include a seventh hole HL7, an eighth hole HL8, and a ninth hole HL9. The seventh hole HL7 may represent a hole extending from the fifth hole HL5 of the seventh oxide layer 357_g, and the ninth hole HL9 may represent a hole extending from the sixth hole HL6 of the seventh oxide layer 357_g. The eighth hole HL8 may be filled with the trench portion 3582 of the passivation layer 358.

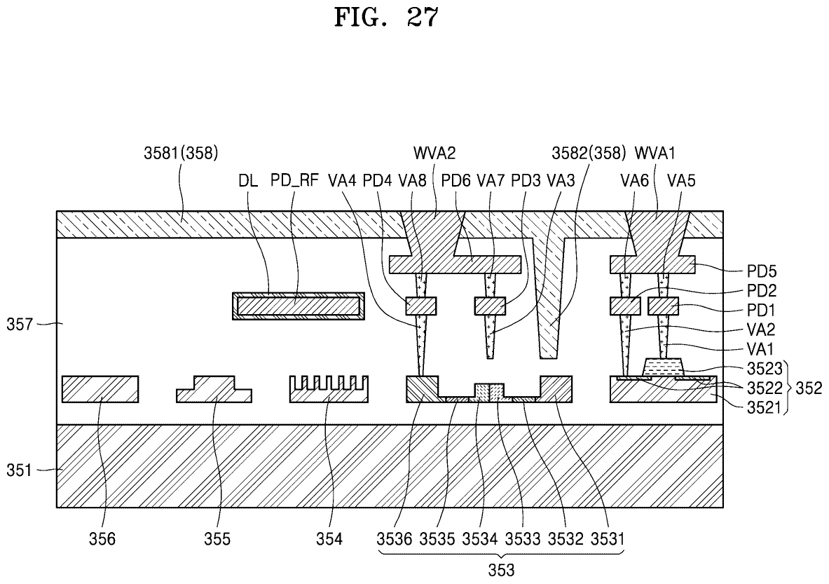

Referring to FIG. 27, the seventh hole HL7 may be filled to form a first wide via WVA1 and the ninth hole HL9 may be filled to form a second wide via WVA2. The first wide via WVA1 may be connected to the fifth pad PD5 and the second wide via WVA2 may be connected to the sixth pad PD6. The first wide via WVA1 and the second wide via WVA2 may be formed through a plating process.

While the inventive concept has been particularly shown and described with reference to embodiments thereof, it will be understood that various changes in form and details may be made therein without departing from the spirit and scope of the following claims.

What is claimed is:

1. A photonic chip structure comprising:
an optical integrated circuit chip comprising a photonic integrated circuit (PIC) connection pad on a first surface of the optical integrated circuit chip;
an electronic integrated circuit chip below the first surface of the optical integrated circuit chip and comprising a through-electrode;
a connection layer between the electronic integrated circuit chip and the optical integrated circuit chip and comprising a conductive pad bonded to the PIC connection pad; and
a lens on a second surface of the optical integrated circuit chip opposite to the first surface of the optical integrated circuit chip, the lens configured to receive an optical signal,
wherein the optical integrated circuit chip comprises a grating coupler configured to couple the optical signal received via the lens.

2. The photonic chip structure of claim 1, wherein the optical integrated circuit chip comprises a reflective pad below the grating coupler, and
wherein at least a portion of the reflective pad overlaps at least a portion of the grating coupler in a second direction.

3. The photonic chip structure of claim 2, wherein the reflective pad has a thickness greater than or equal to 100 nanometers.

4. The photonic chip structure of claim 2, wherein the reflective pad is spaced apart from the grating coupler by about 0.5 micrometers to about 5 micrometers in the second direction.

5. The photonic chip structure of claim 1, wherein the optical integrated circuit chip further comprises:
an oxide layer in which the grating coupler is buried; and
a semiconductor layer located the lens and the oxide layer,
wherein the semiconductor layer comprises a same material as the grating coupler.

6. The photonic chip structure of claim 5, further comprising an anti-reflection layer extending along a surface of the oxide layer and between the oxide layer and the lens.

7. The photonic chip structure of claim 1, wherein a length of the optical integrated circuit chip in a second direction is greater than a length of the electronic integrated circuit chip in the second direction.

8. The photonic chip structure of claim 1, wherein the electronic integrated circuit chip completely overlaps the optical integrated circuit chip in a second direction, and
a width of the optical integrated circuit chip in a first direction perpendicular to the second direction is greater than a width of the electronic integrated circuit chip in the first direction.

9. The photonic chip structure of claim 1, wherein the optical integrated circuit chip further comprises a rib waveguide and a channel waveguide, which are arranged side by side and spaced apart from the grating coupler in a first direction.

10. The photonic chip structure of claim 1, wherein the lens comprises a micro lens.

11. A semiconductor package comprising:
a package substrate;
an interposer mounted on the package substrate;
a first chip structure mounted on the interposer and a second chip structure mounted on the interposer, the first chip structure and the second chip structure spaced apart from each other in a first direction; and
a photonic chip structure spaced apart from the first chip structure in the first direction,
wherein the photonic chip structure comprises:
an optical integrated circuit chip comprising a photonic integrated circuit (PIC) connection pad disposed on a first surface of the optical integrated circuit chip;
an electronic integrated circuit chip below the first surface of the optical integrated circuit chip and comprising a through-electrode;
a connection layer between the electronic integrated circuit chip and the optical integrated circuit chip and comprising a conductive pad aligned with the PIC connection pad; and
a lens disposed above a second surface of the optical integrated circuit chip opposite to the first surface of the optical integrated circuit chip, the lens configured to receive an optical signal,
wherein the optical integrated circuit chip comprises a grating coupler configured to couple the optical signal received via the lens.

12. The semiconductor package of claim 11, wherein the first chip structure comprises a memory chip, and the second chip structure comprises a non-memory chip.

13. The semiconductor package of claim 11, further comprising an anti-reflection layer extending along the second surface of the optical integrated circuit chip and in contact with the lens,
wherein a region of the second surface of the anti-reflection layer not in contact with the lens is exposed.

14. The semiconductor package of claim 11, further comprising a micro bump between the PIC connection pad and the conductive pad to electrically connect the optical integrated circuit chip to the electronic integrated circuit chip.

15. The semiconductor package of claim 11, wherein the conductive pad is bonded to the PIC connection pad.

16. The semiconductor package of claim 11, wherein a length of the electronic integrated circuit chip in a second direction perpendicular to the first direction is in a range of about 10 micrometers to about 50 micrometers.

17. The semiconductor package of claim 11, wherein the optical integrated circuit chip comprises a reflective pad below the grating coupler and overlapping at least a portion of the grating coupler in a second direction perpendicular to the first direction, and
wherein the reflective pad is configured to at least partially reflect the optical signal received via the lens.

18. The semiconductor package of claim 11, wherein the optical integrated circuit chip further comprises a photodetector configured to convert the optical signal received via the lens into an electrical signal.

19. A semiconductor package comprising:
a package substrate;
an interposer mounted on the package substrate;
a memory chip structure mounted on the interposer;
a non-memory chip structure mounted on the interposer and spaced apart from the memory chip structure in a first direction; and
a photonic chip structure spaced apart from the memory chip structure in the first direction with the non-memory chip structure between the photonic chip structure and the memory chip structure,
wherein the photonic chip structure comprises:
an optical integrated circuit chip comprising a photonic integrated circuit (PIC) connection pad on a first surface of the optical integrated circuit chip;
an electronic integrated circuit chip below the first surface of the optical integrated circuit chip and comprising a through-electrode;
a connection layer between the electronic integrated circuit chip and the optical integrated circuit chip, the connection layer comprising a conductive pad bonded to the PIC connection pad; and
a lens above a second surface of the optical integrated circuit chip opposite to the first surface thereof and configured to receive an optical signal, and
wherein the optical integrated circuit chip further comprises a grating coupler configured to couple the optical signal received via the lens, a reflective pad below the grating coupler and overlapping at least a portion of the grating coupler in a second direction perpendicular to the first direction, and a dielectric layer surrounding the reflective pad.

20. The semiconductor package of claim 19, wherein the dielectric layer comprises silicon oxide, silicon nitride, or a combination thereof, and
the reflective pad comprises copper (Cu), silver (Ag), gold (Au), aluminum (Al) or a combination thereof.
